(19) United States
(12) Patent Application Publication
(10) Pub. No.: US 2025/0350914 A1
(43) Pub. Date: Nov. 13, 2025

(54) USER INTERFACES FOR COMMUNICATION USING AN ELECTRONIC DEVICE

(71) Applicant: Apple Inc., Cupertino, CA (US)

(72) Inventors: Jae Woo CHANG, Los Altos Hills, CA (US); Christopher D. LAURITZEN, San Francisco, CA (US); Heather E. DANIEL, San Jose, CA (US)

(21) Appl. No.: 19/043,241

(22) Filed: Jan. 31, 2025

Related U.S. Application Data
(60) Provisional application No. 63/646,800, filed on May 13, 2024.
(60) Provisional application No. 63/657,063, filed on Jun. 6, 2024.

(51) Int. Cl. H04W 4/90; H04M 3/51

(52) U.S. Cl. CPC H04W 4/90; H04M 3/5116; H04M 2201/50; H04M 2242/04

(57) ABSTRACT

The present disclosure generally relates to techniques for providing emergency communication using electronic devices. In some embodiments, user interfaces are provided for sharing media during an emergency call. In some embodiments, user interfaces are provided for accessing content shared during an emergency call.

### CROSS-REFERENCE TO RELATED APPLICATIONS

This application claims priority to U.S. Provisional Application Ser. No. 63/657,063, entitled “USER INTERFACES FOR COMMUNICATION USING AN ELECTRONIC DEVICE,” filed Jun. 6, 2024; and U.S. Provisional Application Ser. No. 63/646,800, entitled “USER INTERFACES FOR COMMUNICATION USING AN ELECTRONIC DEVICE,” filed May 13, 2024, the content of each of which is incorporated herein by reference in their entirety.

### FIELD

The present disclosure relates generally to computer user interfaces, and more specifically to techniques for communication using an electronic device, including techniques for emergency communication.

### BACKGROUND

Computer systems can include hardware and/or software for displaying interfaces for various types of communication, including emergency communication.

### BRIEF SUMMARY

Some techniques for providing communication using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for providing communication. Such methods and interfaces optionally complement or replace other methods for providing communication. Such methods and interfaces reduce the cognitive burden on a user and produce a more efficient human-machine interface. For battery-operated computing devices, such methods and interfaces conserve power and increase the time between battery charges.

Example methods are described herein. An example method includes, at a computer system that is in communication with one or more display generation components and one or more input devices: while an emergency call is active between the computer system and a first entity: receiving first data from the first entity, wherein the first data corresponds to a request to share media with the first entity; in response to receiving the first data, displaying, via the one or more display generation components, a set of one or more options for sharing media with the first entity; receiving, via the one or more input devices, a set of one or more inputs directed to the set of one or more options for sharing media with the first entity; and in response to receiving the set of one or more inputs directed to the set of one or more options for sharing media with the first entity: in accordance with a determination that the set of one or more inputs includes a selection of a first option for sharing media with the first entity, initiating a process for sharing media with the first entity; and in accordance with a determination that the set of one or more inputs does not include a selection of the first option for sharing media with the first entity, forgoing initiating a process for sharing media with the first entity.

An example method includes, at a computer system that is in communication with one or more display generation components and one or more input devices: while an emergency call is active between the computer system and a first entity: receiving first data from the first entity, wherein the first data corresponds to a request to access respective content; in response to receiving the first data, displaying, via the one or more display generation components, a set of one or more options for accessing the respective content; receiving, via the one or more input devices, a set of one or more inputs directed to the set of one or more options for accessing the respective content; and in response to receiving the set of one or more inputs directed to the set of one or more options for accessing the respective content: in accordance with a determination that the set of one or more inputs includes a selection of a first option for accessing the respective content, displaying, via the one or more display generation components, a representation of the respective content while continuing the emergency call; and in accordance with a determination that the set of one or more inputs does not include a selection of the first option for accessing the respective content, continuing the emergency call without displaying the representation of the respective content.

Example non-transitory computer-readable storage media are described herein. An example non-transitory computer-readable storage medium stores one or more programs configured to be executed by one or more processors of a computer system that is in communication with one or more display generation components and one or more input devices, the one or more programs including instructions for: while an emergency call is active between the computer system and a first entity: receiving first data from the first entity, wherein the first data corresponds to a request to share media with the first entity; in response to receiving the first data, displaying, via the one or more display generation components, a set of one or more options for sharing media with the first entity; receiving, via the one or more input devices, a set of one or more inputs directed to the set of one or more options for sharing media with the first entity; and in response to receiving the set of one or more inputs directed to the set of one or more options for sharing media with the first entity: in accordance with a determination that the set of one or more inputs includes a selection of a first option for sharing media with the first entity, initiating a process for sharing media with the first entity; and in accordance with a determination that the set of one or more inputs does not include a selection of the first option for sharing media with the first entity, forgoing initiating a process for sharing media with the first entity.

An example non-transitory computer-readable storage medium stores one or more programs configured to be executed by one or more processors of a computer system that is in communication with one or more display generation components and one or more input devices, the one or more programs including instructions for: while an emergency call is active between the computer system and a first entity: receiving first data from the first entity, wherein the first data corresponds to a request to access respective content; in response to receiving the first data, displaying, via the one or more display generation components, a set of one or more options for accessing the respective content; receiving, via the one or more input devices, a set of one or more inputs directed to the set of one or more options for accessing the respective content; and in response to receiving the set of one or more inputs directed to the set of one or more options for accessing the respective content: in accordance with a determination that the set of one or more inputs includes a selection of a first option for accessing the respective content, displaying, via the one or more display generation components, a representation of the respective content while continuing the emergency call; and in accordance with a determination that the set of one or more inputs does not include a selection of the first option for accessing the respective content, continuing the emergency call without displaying the representation of the respective content.

Example transitory computer-readable storage media are described herein. An example transitory computer-readable storage medium stores one or more programs configured to be executed by one or more processors of a computer system that is in communication with one or more display generation components and one or more input devices, the one or more programs including instructions for: while an emergency call is active between the computer system and a first entity: receiving first data from the first entity, wherein the first data corresponds to a request to share media with the first entity; in response to receiving the first data, displaying, via the one or more display generation components, a set of one or more options for sharing media with the first entity; receiving, via the one or more input devices, a set of one or more inputs directed to the set of one or more options for sharing media with the first entity; and in response to receiving the set of one or more inputs directed to the set of one or more options for sharing media with the first entity: in accordance with a determination that the set of one or more inputs includes a selection of a first option for sharing media with the first entity, initiating a process for sharing media with the first entity; and in accordance with a determination that the set of one or more inputs does not include a selection of the first option for sharing media with the first entity, forgoing initiating a process for sharing media with the first entity.

An example transitory computer-readable storage medium stores one or more programs configured to be executed by one or more processors of a computer system that is in communication with one or more display generation components and one or more input devices, the one or more programs including instructions for: while an emergency call is active between the computer system and a first entity: receiving first data from the first entity, wherein the first data corresponds to a request to access respective content; in response to receiving the first data, displaying, via the one or more display generation components, a set of one or more options for accessing the respective content; receiving, via the one or more input devices, a set of one or more inputs directed to the set of one or more options for accessing the respective content; and in response to receiving the set of one or more inputs directed to the set of one or more options for accessing the respective content: in accordance with a determination that the set of one or more inputs includes a selection of a first option for accessing the respective content, displaying, via the one or more display generation components, a representation of the respective content while continuing the emergency call; and in accordance with a determination that the set of one or more inputs does not include a selection of the first option for accessing the respective content, continuing the emergency call without displaying the representation of the respective content.

Example computer systems are described herein. An example computer system is configured to communicate with one or more display generation components and one or more input devices and includes: one or more processors; and memory storing one or more programs configured to be executed by the one or more processors, the one or more programs including instructions for: while an emergency call is active between the computer system and a first entity: receiving first data from the first entity, wherein the first data corresponds to a request to share media with the first entity; in response to receiving the first data, displaying, via the one or more display generation components, a set of one or more options for sharing media with the first entity; receiving, via the one or more input devices, a set of one or more inputs directed to the set of one or more options for sharing media with the first entity; and in response to receiving the set of one or more inputs directed to the set of one or more options for sharing media with the first entity: in accordance with a determination that the set of one or more inputs includes a selection of a first option for sharing media with the first entity, initiating a process for sharing media with the first entity; and in accordance with a determination that the set of one or more inputs does not include a selection of the first option for sharing media with the first entity, forgoing initiating a process for sharing media with the first entity.

An example computer system is configured to communicate with one or more display generation components and one or more input devices and includes: one or more processors; and memory storing one or more programs configured to be executed by the one or more processors, the one or more programs including instructions for: while an emergency call is active between the computer system and a first entity: receiving first data from the first entity, wherein the first data corresponds to a request to access respective content; in response to receiving the first data, displaying, via the one or more display generation components, a set of one or more options for accessing the respective content; receiving, via the one or more input devices, a set of one or more inputs directed to the set of one or more options for accessing the respective content; and in response to receiving the set of one or more inputs directed to the set of one or more options for accessing the respective content: in accordance with a determination that the set of one or more inputs includes a selection of a first option for accessing the respective content, displaying, via the one or more display generation components, a representation of the respective content while continuing the emergency call; and in accordance with a determination that the set of one or more inputs does not include a selection of the first option for accessing the respective content, continuing the emergency call without displaying the representation of the respective content.

An example computer system is configured to communicate with one or more display generation components and one or more input devices and includes: means for while an emergency call is active between the computer system and a first entity: receiving first data from the first entity, wherein the first data corresponds to a request to share media with the first entity; in response to receiving the first data, displaying, via the one or more display generation components, a set of one or more options for sharing media with the first entity; receiving, via the one or more input devices, a set of one or more inputs directed to the set of one or more options for sharing media with the first entity; and in response to receiving the set of one or more inputs directed to the set of one or more options for sharing media with the first entity: in accordance with a determination that the set of one or more inputs includes a selection of a first option for sharing media with the first entity, initiating a process for sharing media with the first entity; and in accordance with a determination that the set of one or more inputs does not include a selection of the first option for sharing media with the first entity, forgoing initiating a process for sharing media with the first entity.

An example computer system is configured to communicate with one or more display generation components and one or more input devices and includes: means for while an emergency call is active between the computer system and a first entity: receiving first data from the first entity, wherein the first data corresponds to a request to access respective content; in response to receiving the first data, displaying, via the one or more display generation components, a set of one or more options for accessing the respective content; receiving, via the one or more input devices, a set of one or more inputs directed to the set of one or more options for accessing the respective content; and in response to receiving the set of one or more inputs directed to the set of one or more options for accessing the respective content: in accordance with a determination that the set of one or more inputs includes a selection of a first option for accessing the respective content, displaying, via the one or more display generation components, a representation of the respective content while continuing the emergency call; and in accordance with a determination that the set of one or more inputs does not include a selection of the first option for accessing the respective content, continuing the emergency call without displaying the representation of the respective content.

Example computer program products are described herein. An example computer program product includes one or more programs configured to be executed by one or more processors of a computer system that is in communication with one or more display generation components and one or more input devices, the one or more programs including instructions for: while an emergency call is active between the computer system and a first entity: receiving first data from the first entity, wherein the first data corresponds to a request to share media with the first entity; in response to receiving the first data, displaying, via the one or more display generation components, a set of one or more options for sharing media with the first entity; receiving, via the one or more input devices, a set of one or more inputs directed to the set of one or more options for sharing media with the first entity; and in response to receiving the set of one or more inputs directed to the set of one or more options for sharing media with the first entity: in accordance with a determination that the set of one or more inputs includes a selection of a first option for sharing media with the first entity, initiating a process for sharing media with the first entity; and in accordance with a determination that the set of one or more inputs does not include a selection of the first option for sharing media with the first entity, forgoing initiating a process for sharing media with the first entity.

An example computer program product includes one or more programs configured to be executed by one or more processors of a computer system that is in communication with one or more display generation components and one or more input devices, the one or more programs including instructions for: while an emergency call is active between the computer system and a first entity: receiving first data from the first entity, wherein the first data corresponds to a request to access respective content; in response to receiving the first data, displaying, via the one or more display generation components, a set of one or more options for accessing the respective content; receiving, via the one or more input devices, a set of one or more inputs directed to the set of one or more options for accessing the respective content; and in response to receiving the set of one or more inputs directed to the set of one or more options for accessing the respective content: in accordance with a determination that the set of one or more inputs includes a selection of a first option for accessing the respective content, displaying, via the one or more display generation components, a representation of the respective content while continuing the emergency call; and in accordance with a determination that the set of one or more inputs does not include a selection of the first option for accessing the respective content, continuing the emergency call without displaying the representation of the respective content.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for providing emergency communication, thereby increasing the effectiveness, efficiency, and user satisfaction with such devices. Such methods and interfaces may complement or replace other methods for providing emergency communication.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIG. 5C illustrates an exemplary diagram of a communication session between electronic devices in accordance with some embodiments.

FIGS. 6A-6Y illustrate exemplary user interfaces for sharing media during an emergency call, in accordance with some embodiments.

FIG. 7 is a flow diagram illustrating a method for sharing media during an emergency call, in accordance with some embodiments.

FIGS. 8A-8K illustrate exemplary user interfaces for accessing content shared during an emergency call, in accordance with some embodiments.

FIG. 9 is a flow diagram illustrating a method for accessing content shared during an emergency call, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for providing communication, including techniques for emergency communication and sharing content, such as photos, video, and/or instructions, during a communication session. In some examples, media can be shared with emergency service providers to enhance communication with the emergency service provider. In some examples, content can be accessed from an emergency service provider. Such techniques can reduce the cognitive burden on a user who communicates with emergency service providers, thereby enhancing productivity. Further, such techniques can reduce processor and battery power otherwise wasted on redundant user inputs.

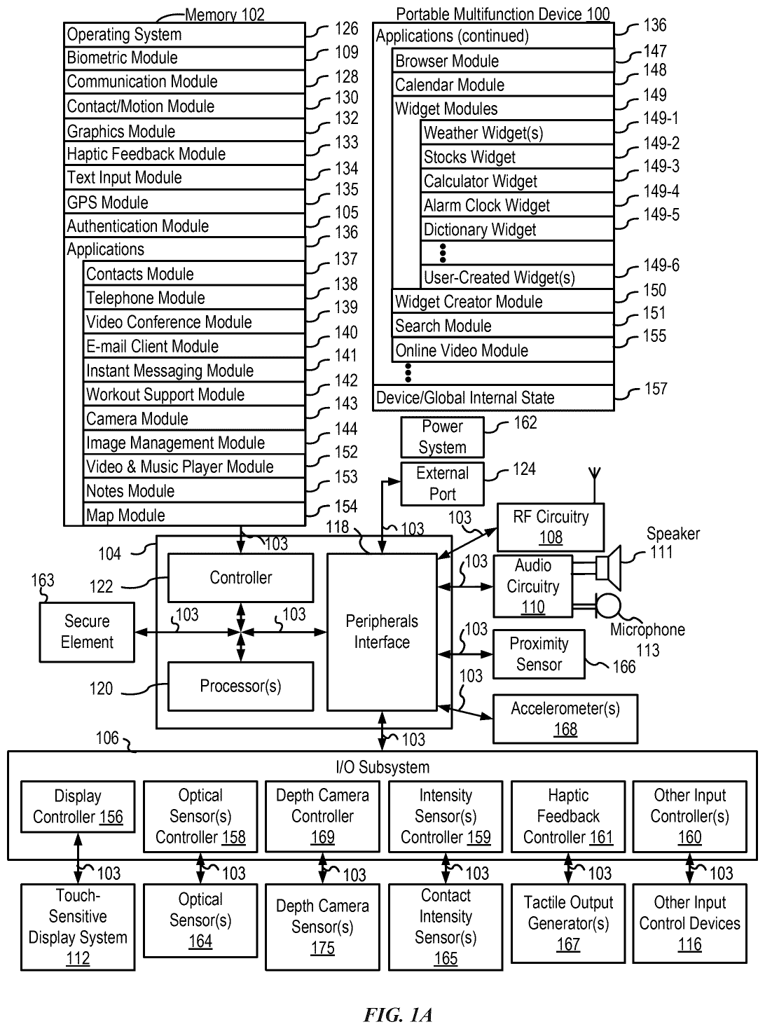

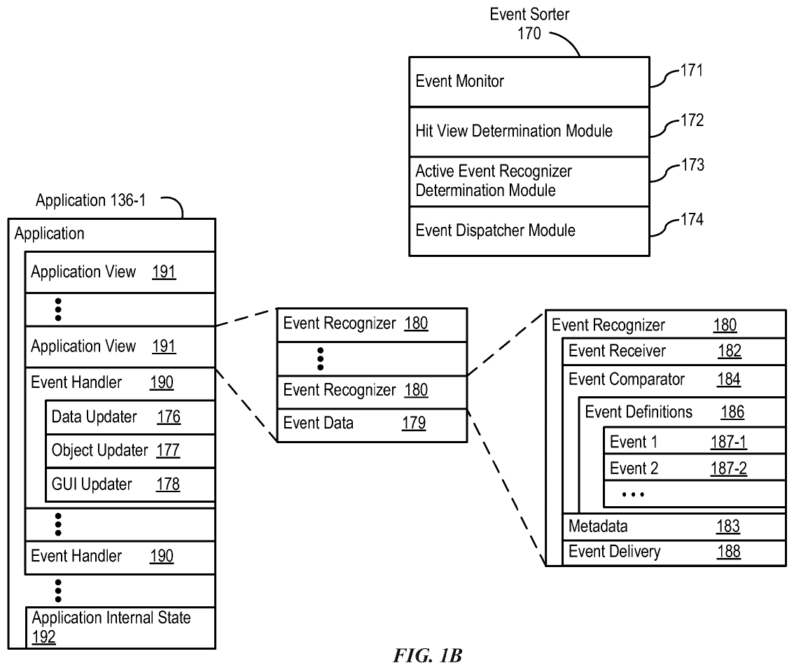

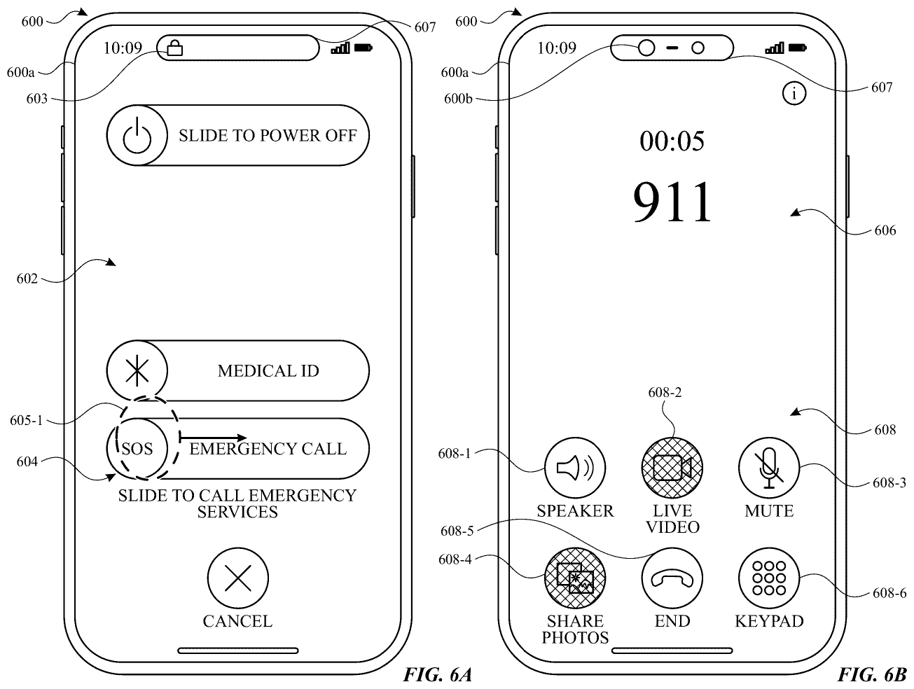

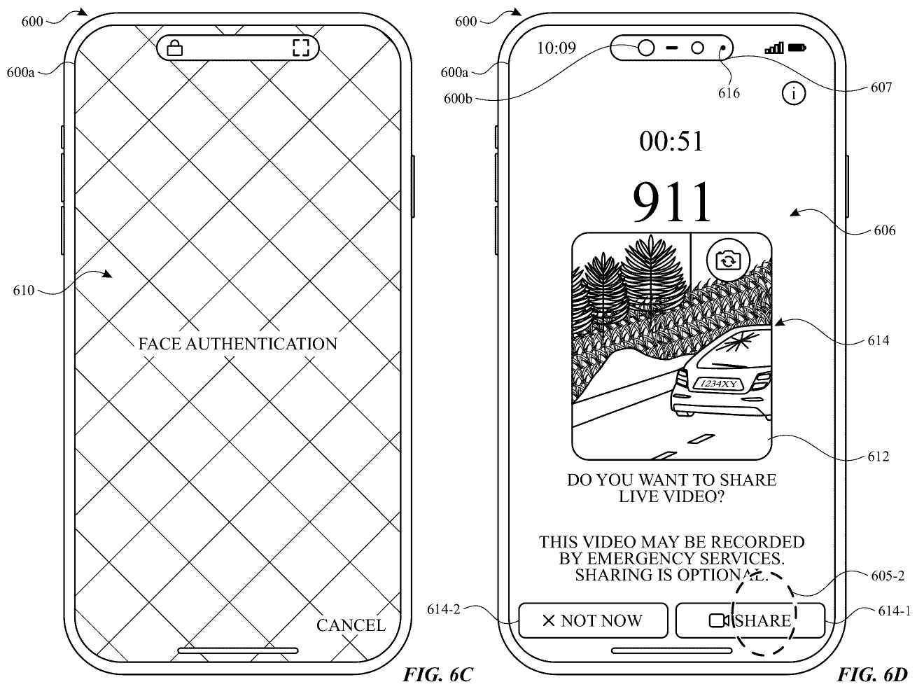

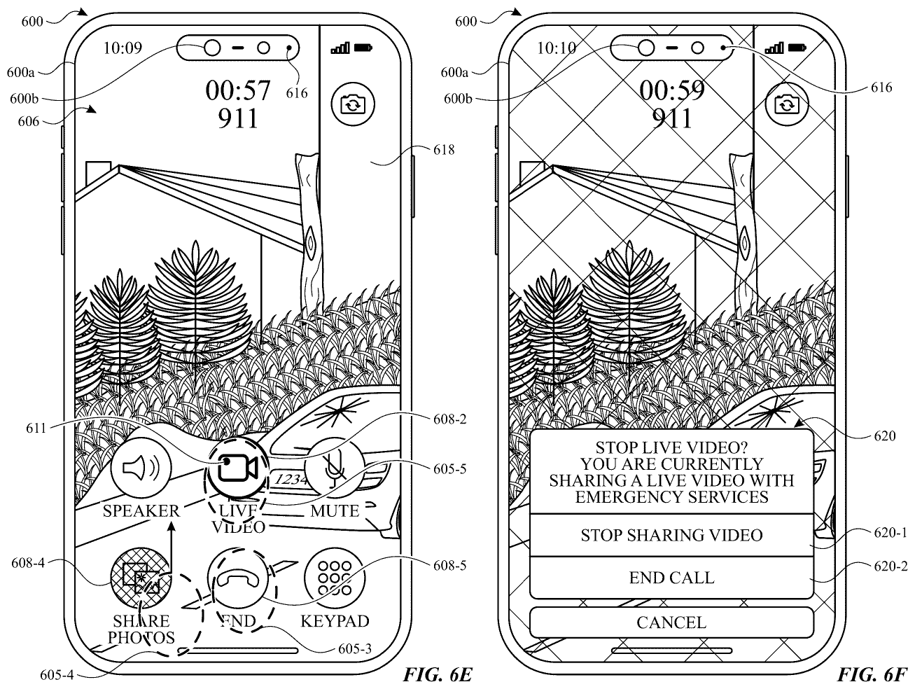

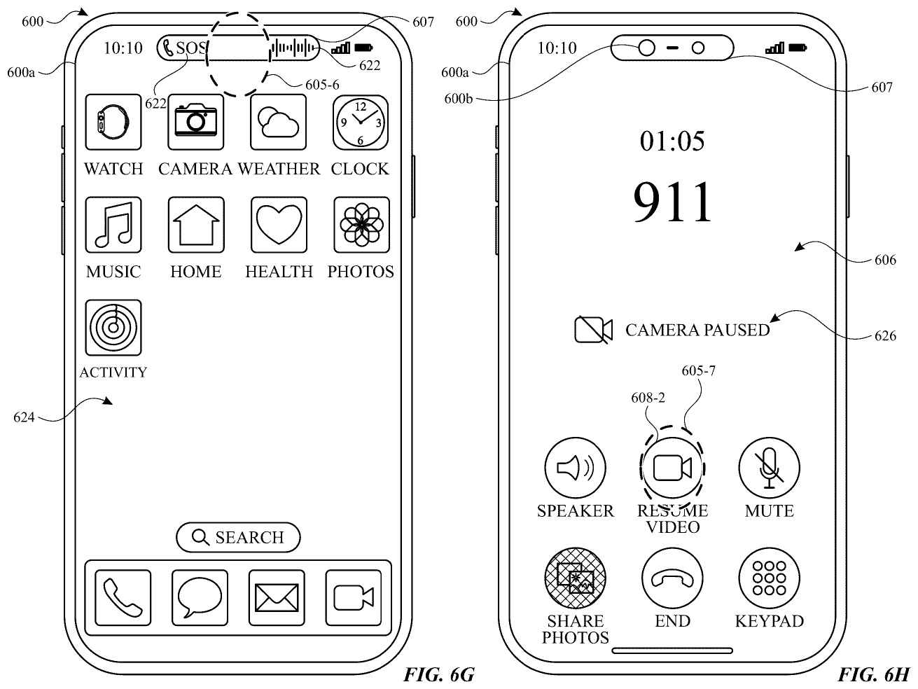

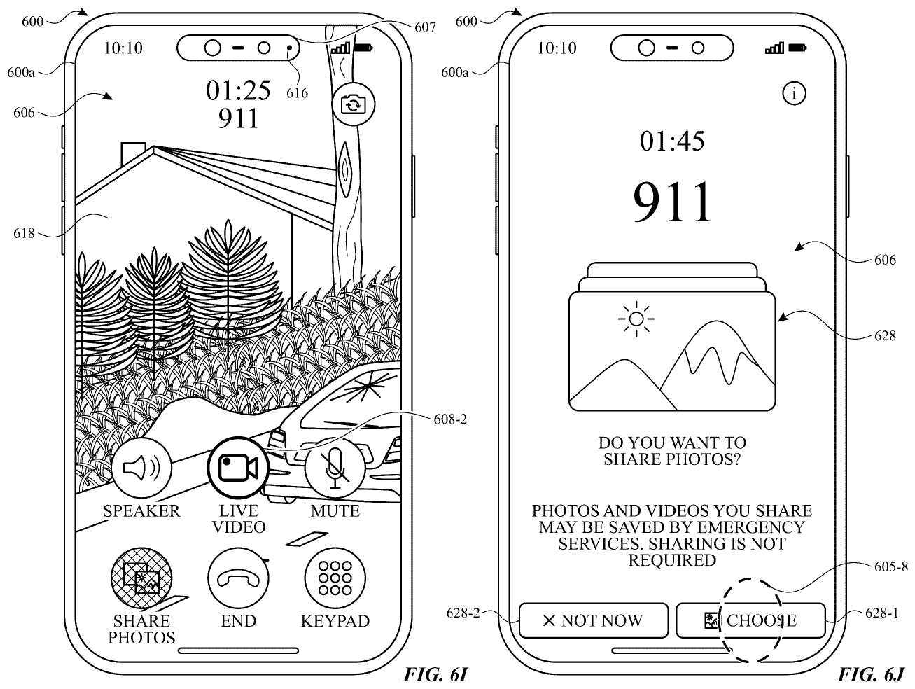

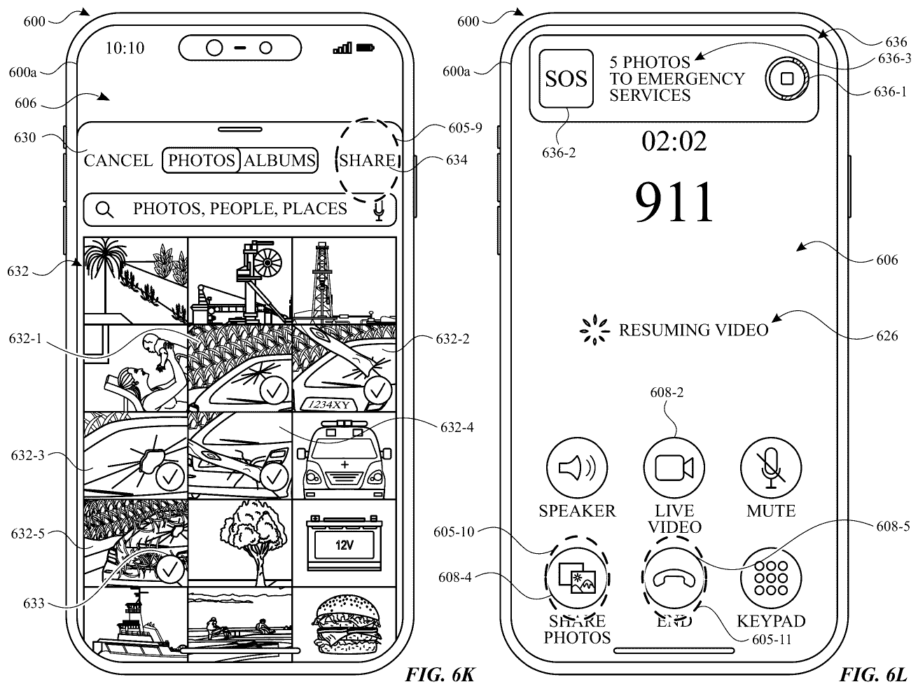

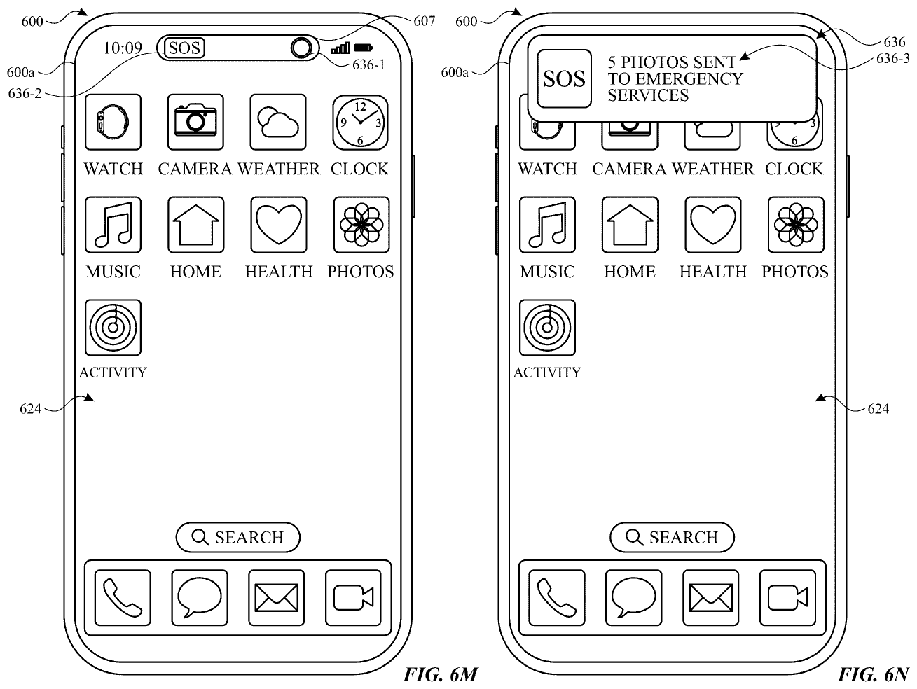

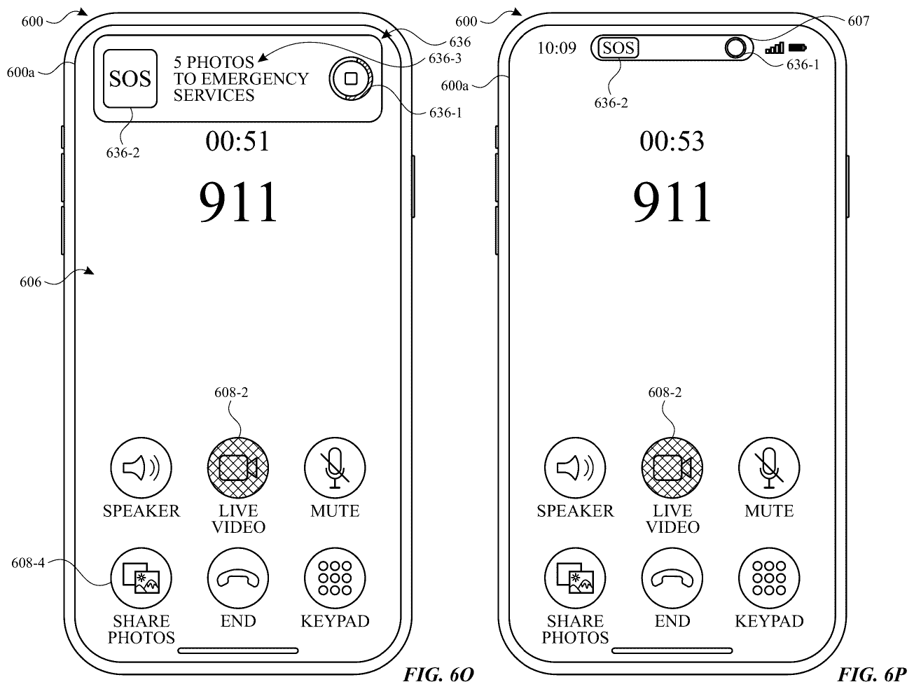

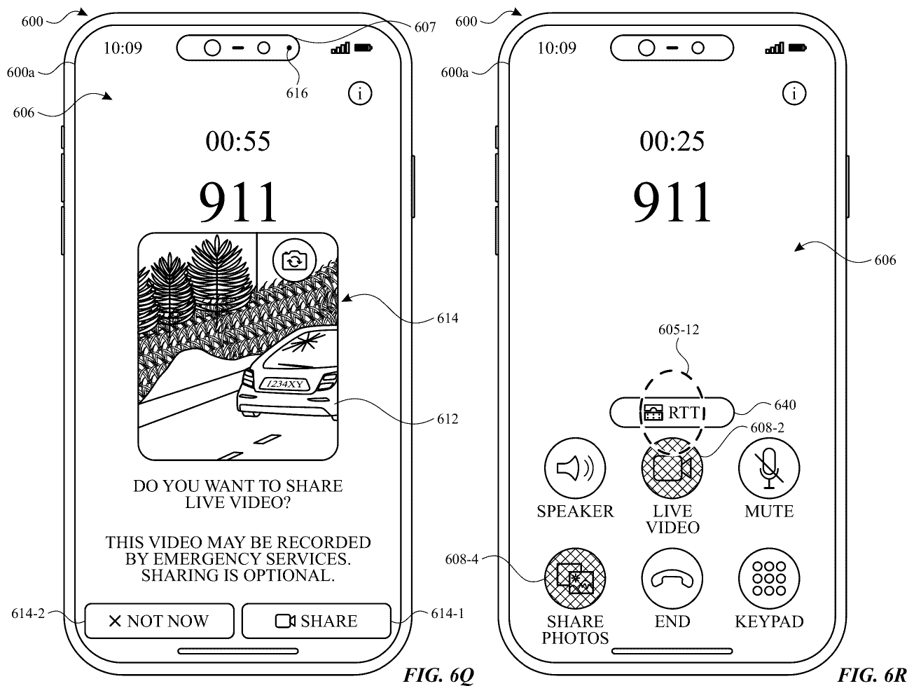

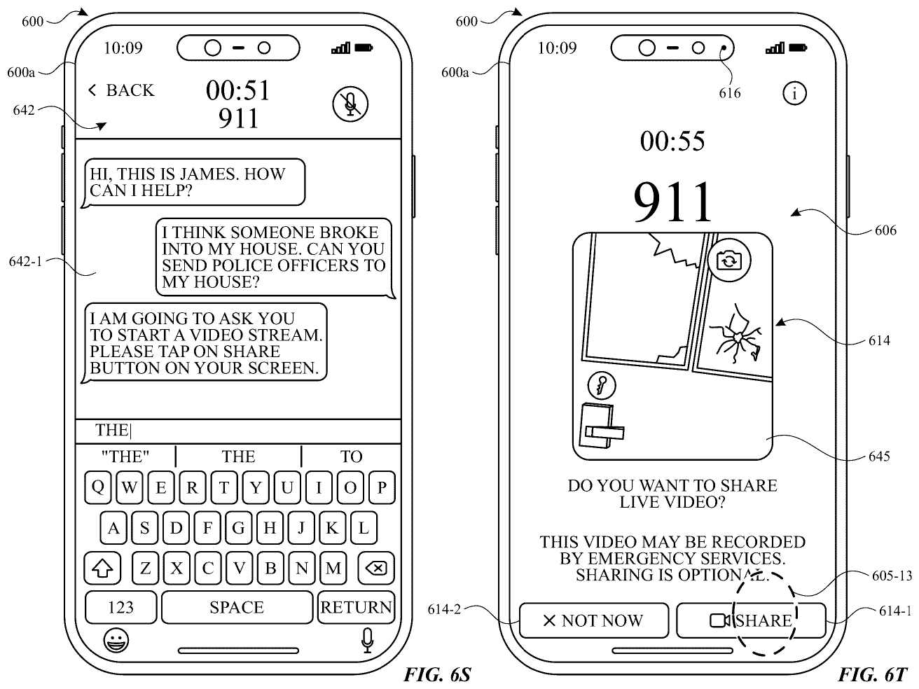

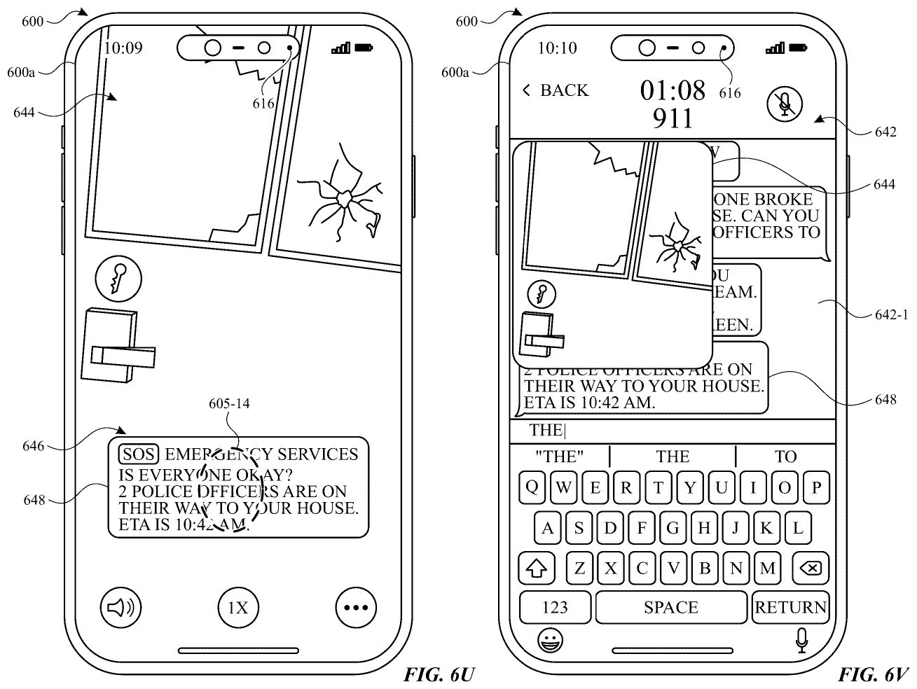

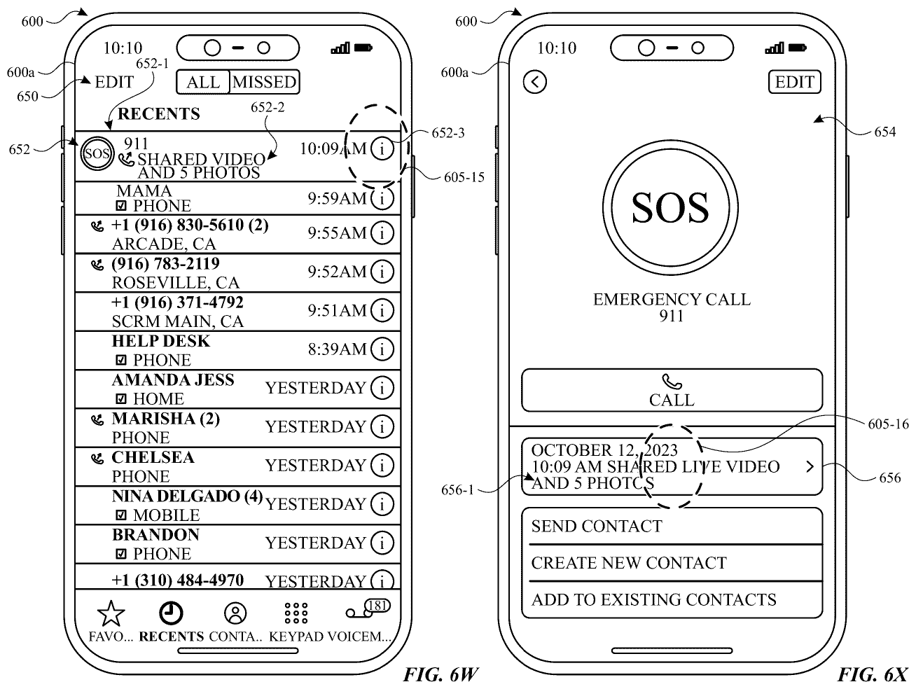

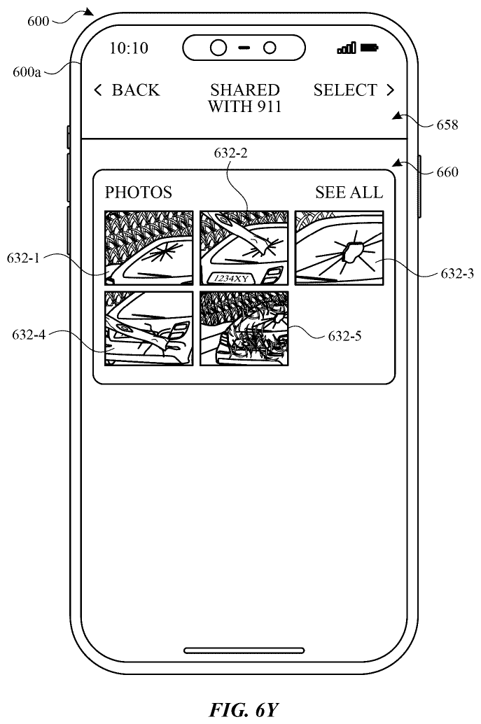

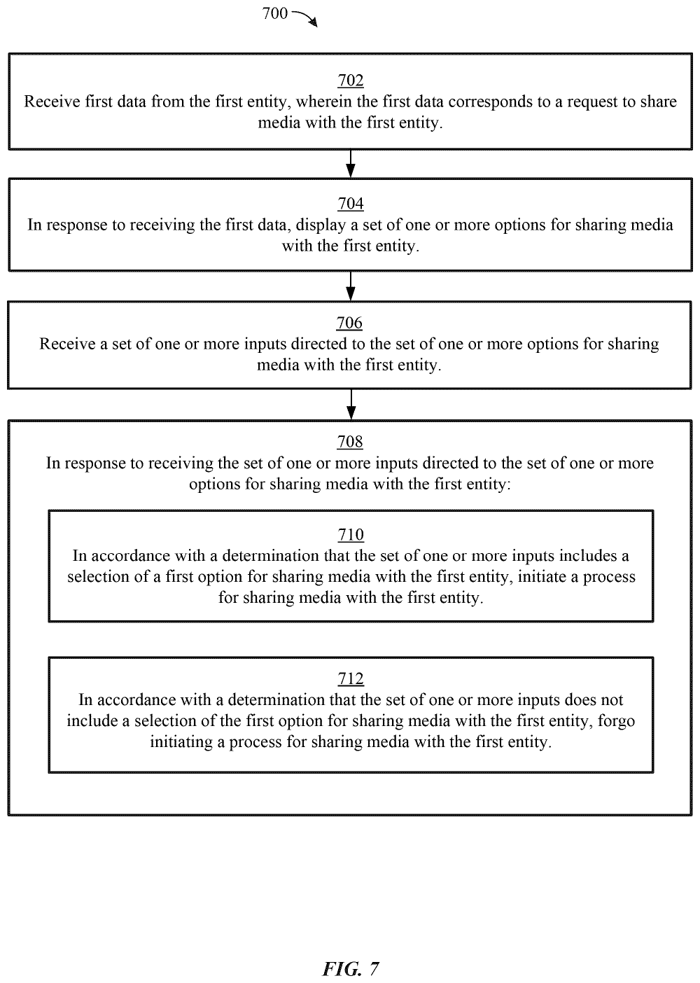

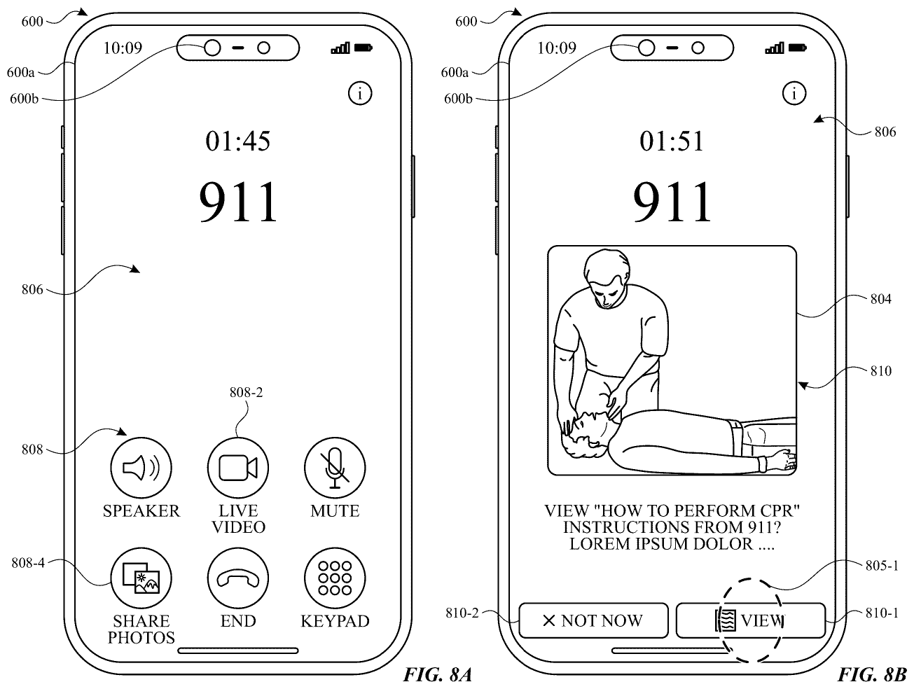

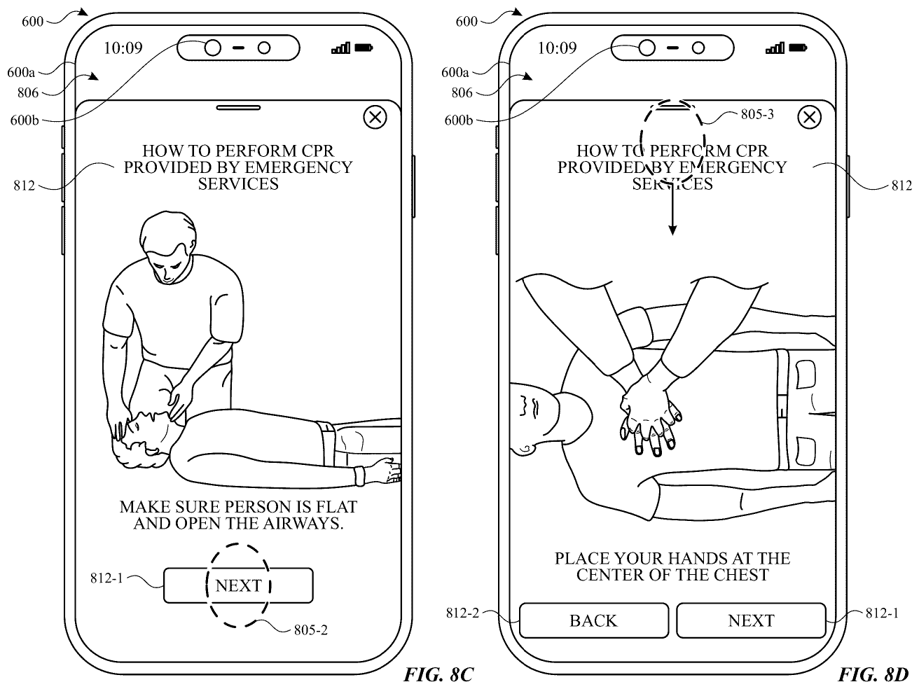

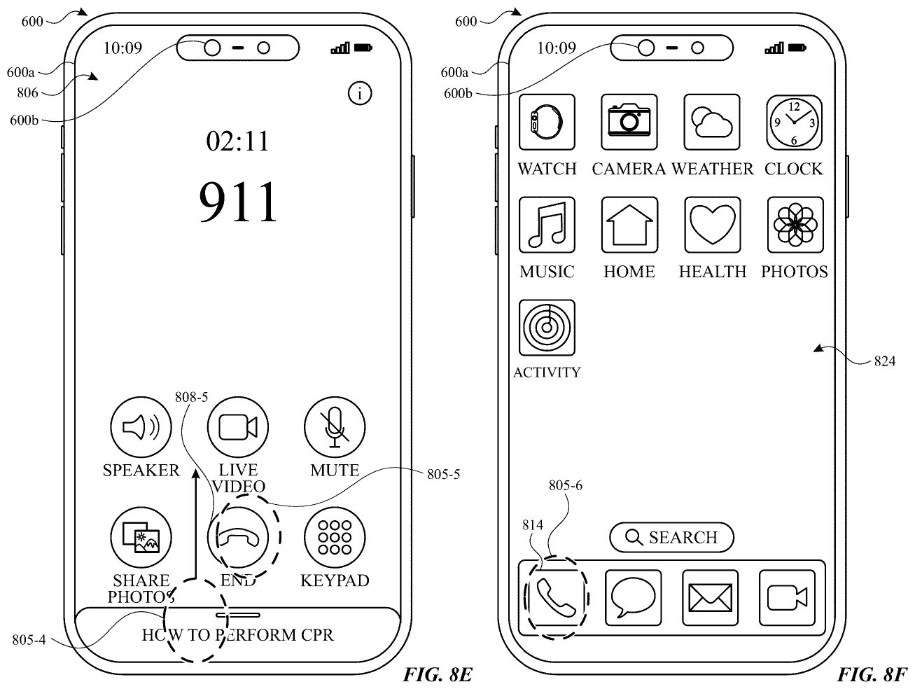

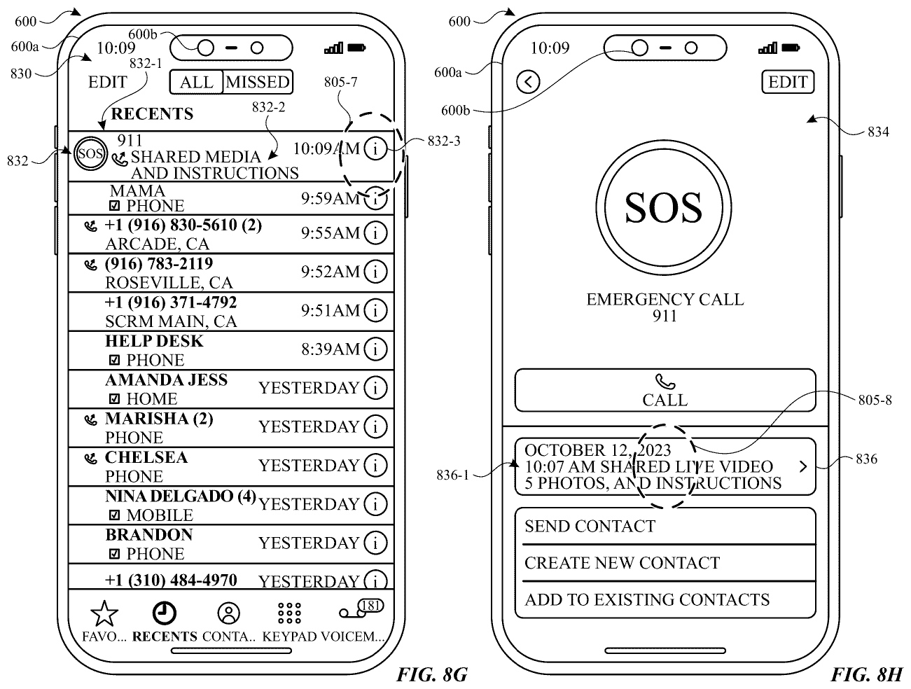

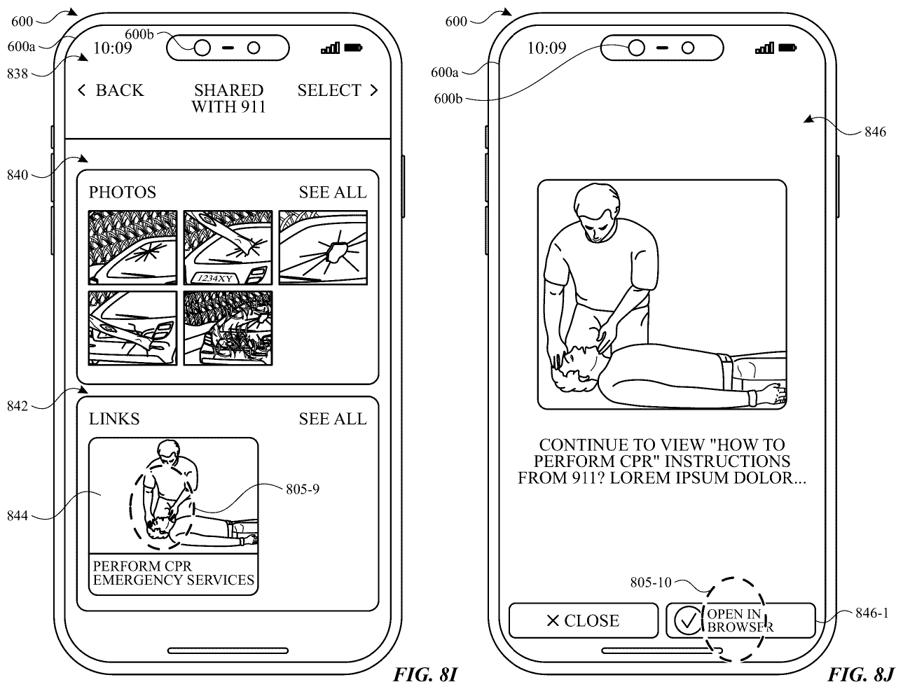

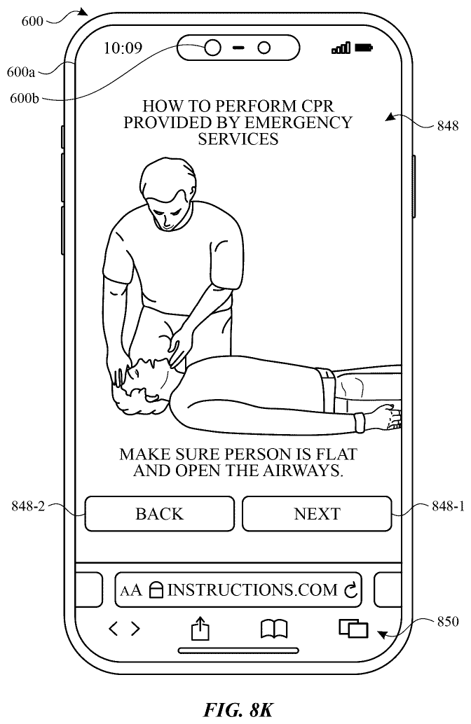

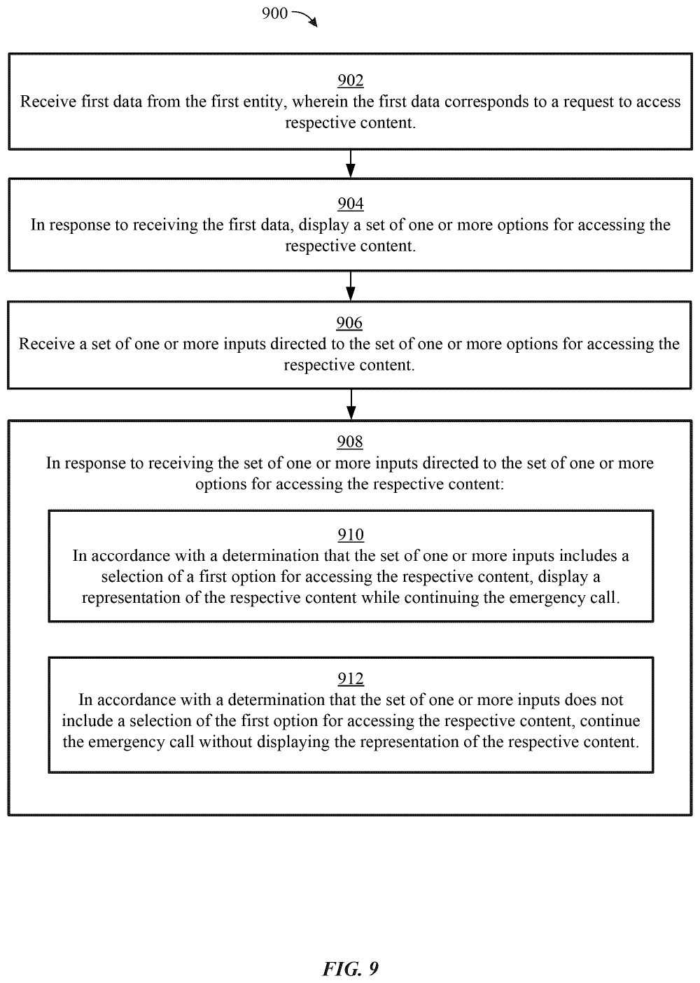

Below, FIGS. 1A-1B, 2, 3A-3G, 4A-4B, and 5A-5C provide a description of exemplary devices for performing the techniques for providing emergency communication. FIGS. 6A-6Y illustrate exemplary user interfaces for sharing media during an emergency call, in accordance with some embodiments. FIG. 7 is a flow diagram illustrating a method for sharing media during an emergency call, in accordance with some embodiments. The user interfaces in FIGS. 6A-6Y are used to illustrate the processes described below, including the processes in FIG. 7. FIGS. 8A-8K illustrate exemplary user interfaces for accessing content shared during an emergency call, in accordance with some embodiments. FIG. 9 is a flow diagram illustrating a method for accessing content shared during an emergency call, in accordance with some embodiments. The user interfaces in FIGS. 8A-8K are used to illustrate the processes described below, including the processes in FIG. 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display 112 in accordance with some embodiments. Touch-sensitive display 112 is sometimes called a “touch screen” or “touch screen display” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or an “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

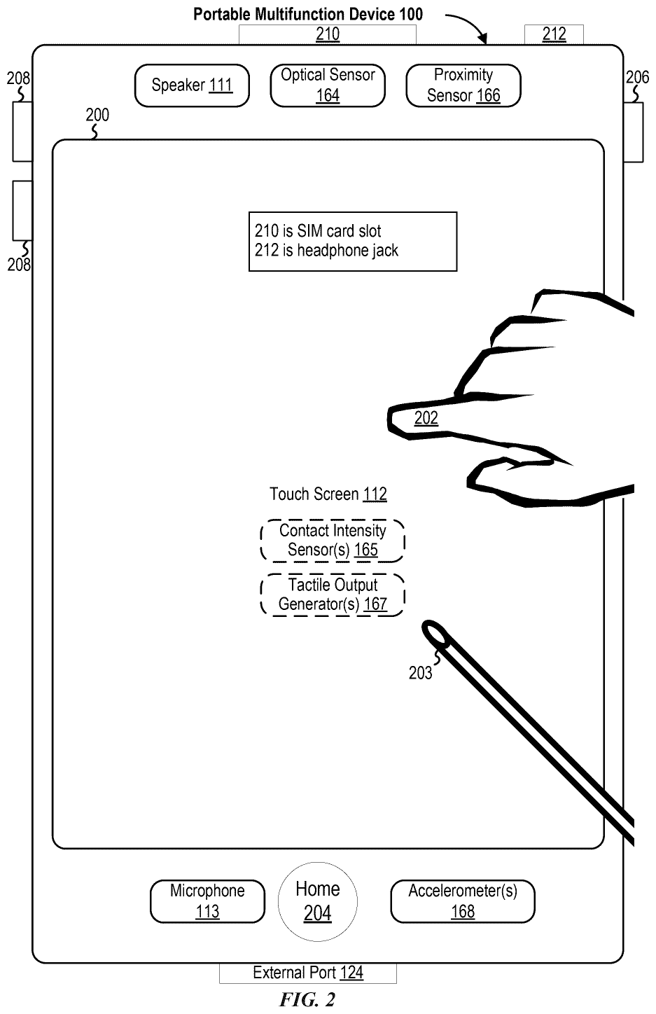

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three-dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

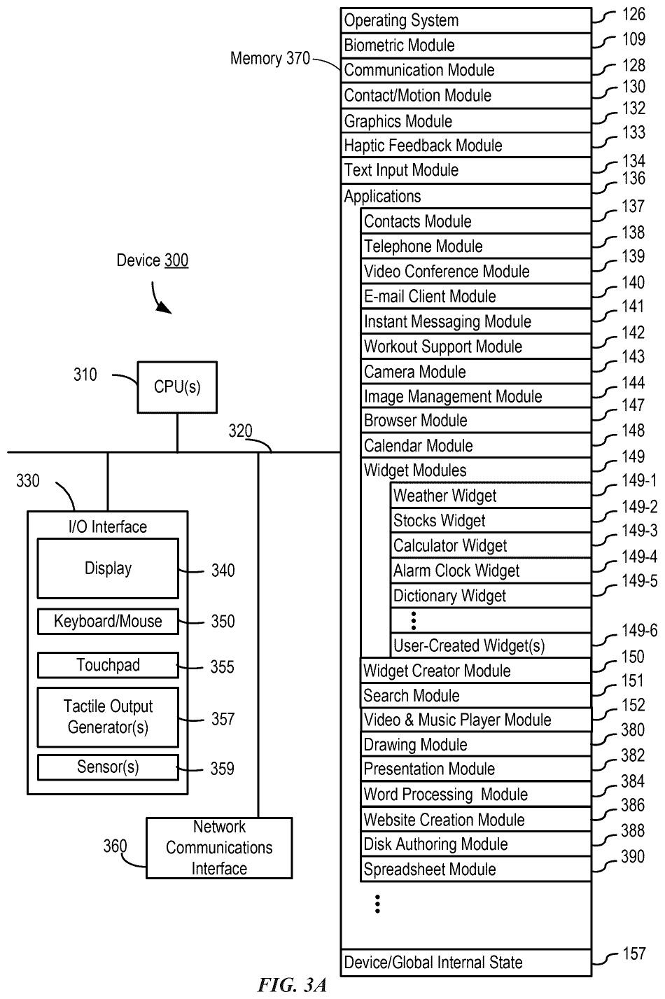

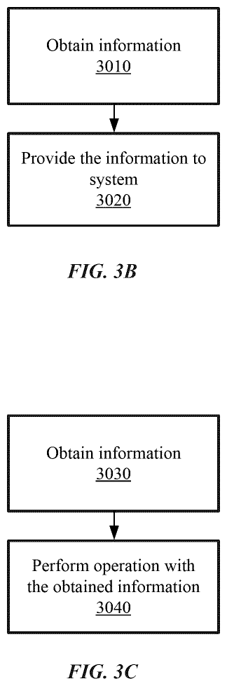

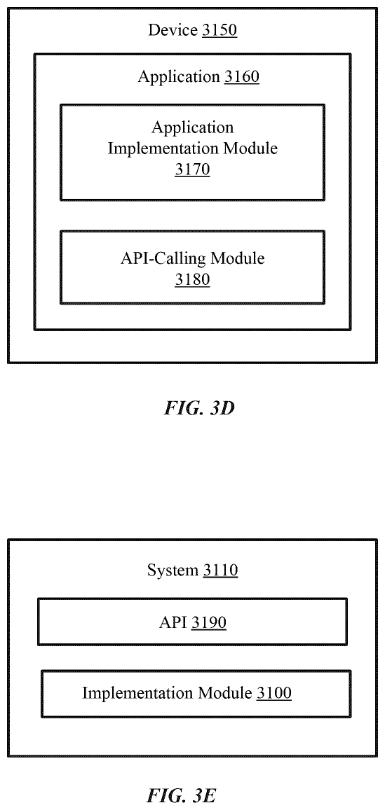

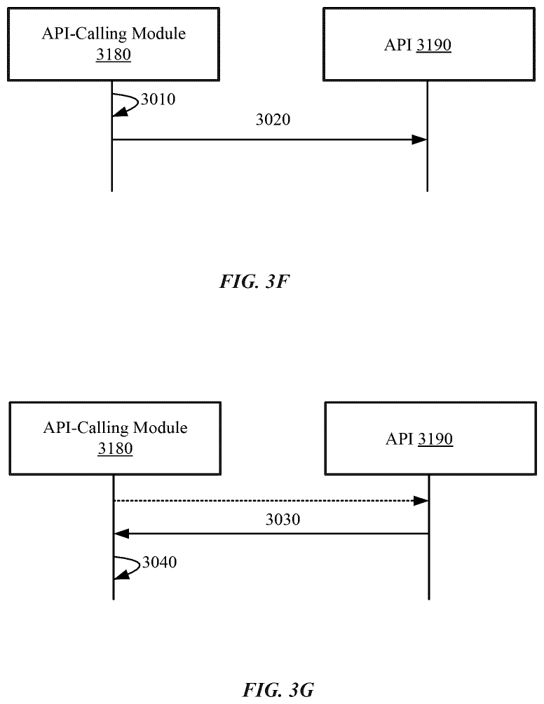

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700 and/or 900 (FIGS. 7 and/or 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

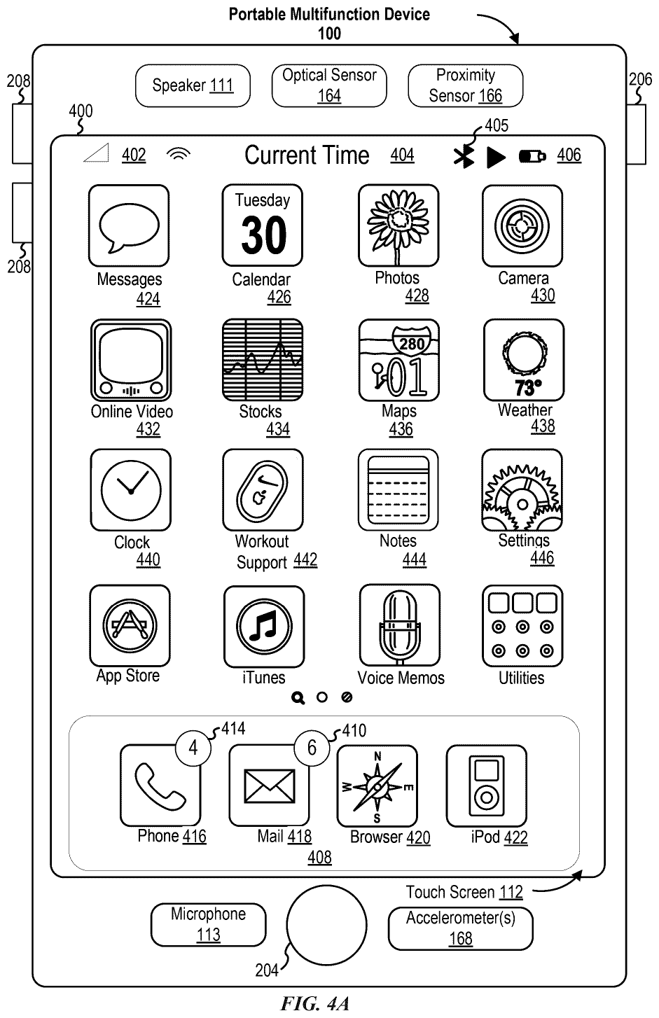

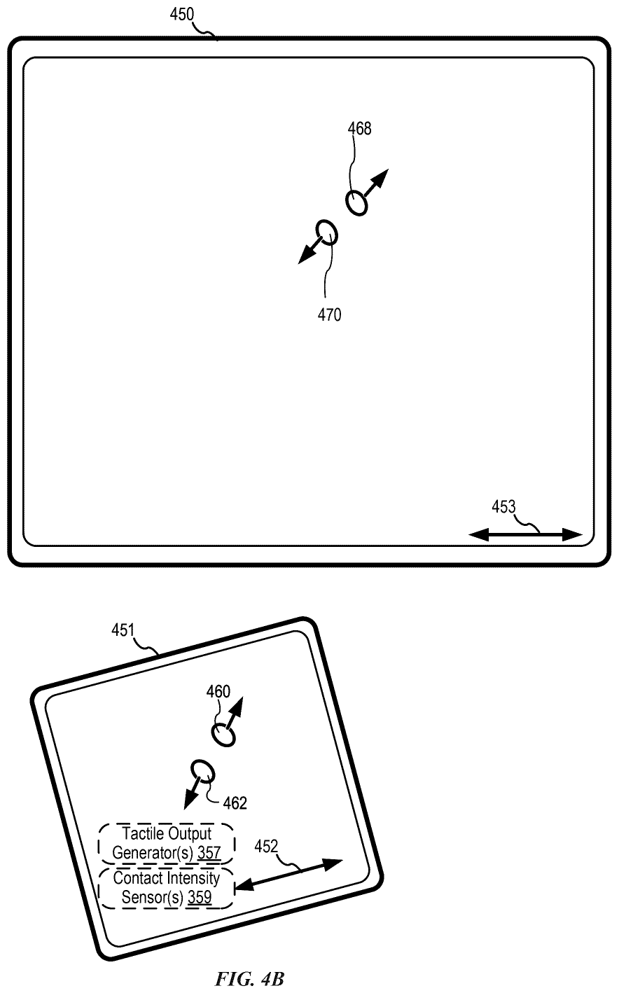

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch-sensitive display 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

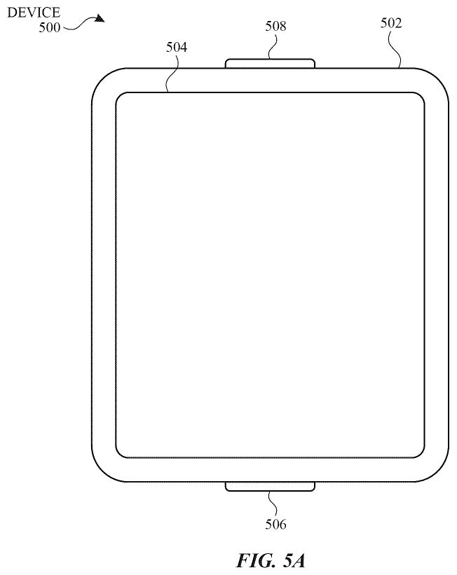

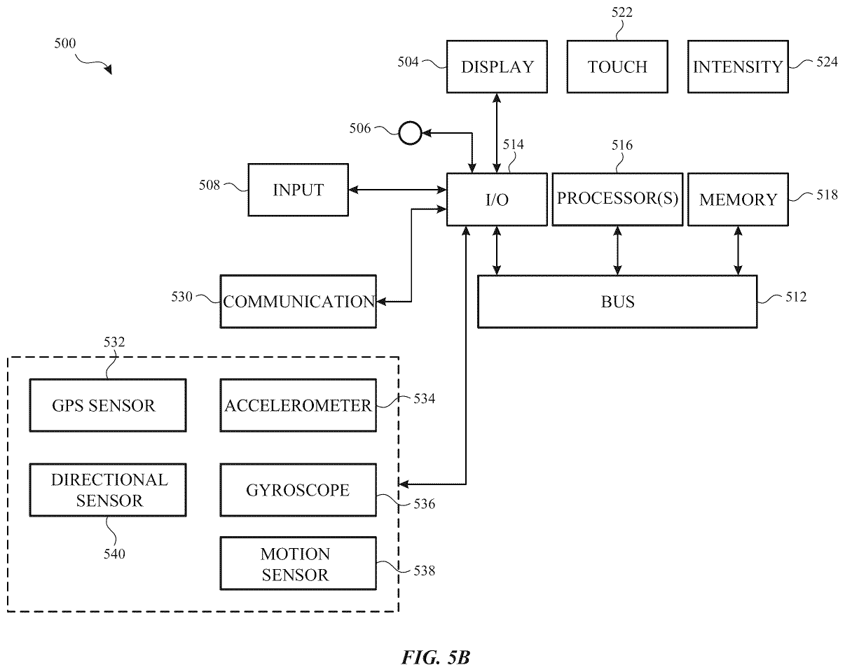

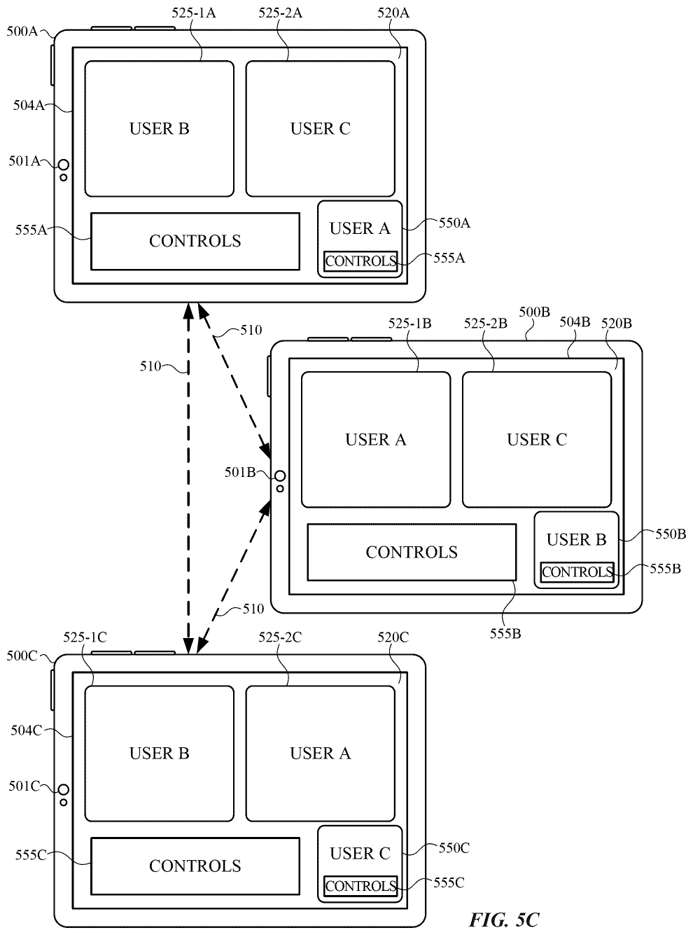

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and 900 (FIGS. 7 and 9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5C). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C depicts an exemplary diagram of a communication session between electronic devices 500A, 500B, and 500C. Devices 500A, 500B, and 500C are similar to electronic device 500, and each share with each other one or more data connections 510 such as an Internet connection, Wi-Fi connection, cellular connection, short-range communication connection, and/or any other such data connection or network so as to facilitate real time communication of audio and/or video data between the respective devices for a duration of time. In some embodiments, an exemplary communication session can include a shared-data session whereby data is communicated from one or more of the electronic devices to the other electronic devices to enable concurrent output of respective content at the electronic devices. In some embodiments, an exemplary communication session can include a video conference session whereby audio and/or video data is communicated between devices 500A, 500B, and 500C such that users of the respective devices can engage in real-time communication using the electronic devices.

In FIG. 5C, device 500A represents an electronic device associated with User A. Device 500A is in communication (via data connections 510) with devices 500B and 500C, which are associated with User B and User C, respectively. Device 500A includes camera 501A, which is used to capture video data for the communication session, and display 504A (e.g., a touchscreen), which is used to display content associated with the communication session. Device 500A also includes other components, such as a microphone (e.g., 113) for recording audio for the communication session and a speaker (e.g., 111) for outputting audio for the communication session.

Device 500A displays, via display 504A, communication UI 520A, which is a user interface for facilitating a communication session (e.g., a video conference session) between device 500B and device 500C. Communication UI 520A includes video feed 525-1A and video feed 525-2A. Video feed 525-1A is a representation of video data captured at device 500B (e.g., using camera 501B) and communicated from device 500B to devices 500A and 500C during the communication session. Video feed 525-2A is a representation of video data captured at device 500C (e.g., using camera 501C) and communicated from device 500C to devices 500A and 500B during the communication session.

Communication UI 520A includes camera preview 550A, which is a representation of video data captured at device 500A via camera 501A. Camera preview 550A represents to User A the prospective video feed of User A that is displayed at respective devices 500B and 500C.

Communication UI 520A includes one or more controls 555A for controlling one or more aspects of the communication session. For example, controls 555A can include controls for muting audio for the communication session, changing a camera view for the communication session (e.g., changing which camera is used for capturing video for the communication session, adjusting a zoom value), terminating the communication session, applying visual effects to the camera view for the communication session, activating one or more modes associated with the communication session. In some embodiments, one or more controls 555A are optionally displayed in communication UI 520A. In some embodiments, one or more controls 555A are displayed separate from camera preview 550A. In some embodiments, one or more controls 555A are displayed overlaying at least a portion of camera preview 550A.

In FIG. 5C, device 500B represents an electronic device associated with User B, which is in communication (via data connections 510) with devices 500A and 500C. Device 500B includes camera 501B, which is used to capture video data for the communication session, and display 504B (e.g., a touchscreen), which is used to display content associated with the communication session. Device 500B also includes other components, such as a microphone (e.g., 113) for recording audio for the communication session and a speaker (e.g., 111) for outputting audio for the communication session.

Device 500B displays, via touchscreen 504B, communication UI 520B, which is similar to communication UI 520A of device 500A. Communication UI 520B includes video feed 525-1B and video feed 525-2B. Video feed 525-1B is a representation of video data captured at device 500A (e.g., using camera 501A) and communicated from device 500A to devices 500B and 500C during the communication session. Video feed 525-2B is a representation of video data captured at device 500C (e.g., using camera 501C) and communicated from device 500C to devices 500A and 500B during the communication session. Communication UI 520B also includes camera preview 550B, which is a representation of video data captured at device 500B via camera 501B, and one or more controls 555B for controlling one or more aspects of the communication session, similar to controls 555A. Camera preview 550B represents to User B the prospective video feed of User B that is displayed at respective devices 500A and 500C.

In FIG. 5C, device 500C represents an electronic device associated with User C, which is in communication (via data connections 510) with devices 500A and 500B. Device 500C includes camera 501C, which is used to capture video data for the communication session, and display 504C (e.g., a touchscreen), which is used to display content associated with the communication session. Device 500C also includes other components, such as a microphone (e.g., 113) for recording audio for the communication session and a speaker (e.g., 111) for outputting audio for the communication session.

Device 500C displays, via touchscreen 504C, communication UI 520C, which is similar to communication UI 520A of device 500A and communication UI 520B of device 500B. Communication UI 520C includes video feed 525-1C and video feed 525-2C. Video feed 525-1C is a representation of video data captured at device 500B (e.g., using camera 501B) and communicated from device 500B to devices 500A and 500C during the communication session. Video feed 525-2C is a representation of video data captured at device 500A (e.g., using camera 501A) and communicated from device 500A to devices 500B and 500C during the communication session. Communication UI 520C also includes camera preview 550C, which is a representation of video data captured at device 500C via camera 501C, and one or more controls 555C for controlling one or more aspects of the communication session, similar to controls 555A and 555B. Camera preview 550C represents to User C the prospective video feed of User C that is displayed at respective devices 500A and 500B.

While the diagram depicted in FIG. 5C represents a communication session between three electronic devices, the communication session can be established between two or more electronic devices, and the number of devices participating in the communication session can change as electronic devices join or leave the communication session. For example, if one of the electronic devices leaves the communication session, audio and video data from the device that stopped participating in the communication session is no longer represented on the participating devices. For example, if device 500B stops participating in the communication session, there is no data connection 510 between devices 500A and 500C, and no data connection 510 between devices 500C and 500B. Additionally, device 500A does not include video feed 525-1A and device 500C does not include video feed 525-1C. Similarly, if a device joins the communication session, a connection is established between the joining device and the existing devices, and the video and audio data is shared among all devices such that each device is capable of outputting data communicated from the other devices.

The embodiment depicted in FIG. 5C represents a diagram of a communication session between multiple electronic devices, including the example communication sessions depicted in FIGS. 6A-6Y and 8A-8K. In some embodiments, the communication sessions depicted in FIGS. 6A-6Y and 8A-8K include two or more electronic devices, even if other electronic devices participating in the communication session are not depicted in the figures. In some embodiments, the communication sessions depicted in FIGS. 6A-6Y and 8A-8K can include more than two electronic devices.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on an electronic device, such as portable multifunction device 100, device 300, or device 500.

FIGS. 6A-6Y illustrate example user interfaces for sharing media during a call, such as, e.g., an emergency call (e.g., a phone call with an emergency service provider), in accordance with some embodiments. The user interfaces in these figures are used to illustrate the processes described below, including the processes in FIG. 7.

FIG. 6A illustrates device 600 (e.g., a smartphone), which includes display 600a (e.g., a touch-sensitive display) and one or more cameras 600b (shown, for example, in FIG. 6B). In some embodiments, camera(s) 600b can include a front-facing camera (e.g., a camera that is located on the same side of device 600 as display 600a) and/or a rear-facing camera (e.g., a camera that is located on the opposite side of device 600 as display 600a). In the embodiments described herein, reference is made to camera(s) 600b, which is shown as a front-facing camera. However, it should be appreciated that camera(s) 600b can instead refer to a rear-facing camera or both a rear-facing camera and a front-facing camera. In some embodiments, device 600 includes one or more elements from device 100, device 300, and/or device 500.

As shown in FIG. 6A, device 600 displays, via display 600a, user interface 602 (e.g., a lock screen), which includes emergency call slider 604 and lock icon 603 displayed in status region 607 indicating that device 600 is in a locked state. While device 600 is locked (or, in some embodiments, when device 600 is unlocked), emergency call slider 604 can be activated (e.g., via input 605-1) to initiate a call (e.g., a phone call and/or an audio call) with an emergency service provider such as police services, fire services, paramedics, or the like. In some embodiments, the call can be initiated using a keypad interface of device 600 (e.g., dialing the numbers “911” and selecting a call element to place the call to “911”). In the embodiments described herein, the call is a phone call to “911” and, when connected, the call is established between a user using device 600 and a representative (e.g., a dispatcher) of the emergency service provider. The emergency service provider includes a computer system that enables the representative of the emergency service provider to, among other things, activate features for enhancing communication between device 600 and the emergency service provider. For example, in the embodiments described with respect to FIGS. 6A-6Y, the representative of the emergency service provider can enable the sharing of media during the emergency call. As another example, in the embodiments described with respect to FIGS. 8A-8K, the representative of the emergency service provider can enable the sharing of content, such as Public Safety Answering Point (PSAP) content, during the call. As described in greater detail below, the emergency service provider is capable of transmitting data to device 600 to enable the sharing of a live video feed, media, or PSAP content using device 600.

In FIG. 6B, in response to detecting input 605-1 (e.g., a touch-and-slide gesture on emergency call slider 604 and/or other activation input), device 600 places an emergency call to “911” and the emergency call is established between device 600 and the emergency service provider. Device 600 displays call interface 606, which indicates an emergency call is established with “911” and provides call elements 608 that are selectable (e.g., when enabled) to perform various functions associated with the emergency call. For example, audio output element 608-1 is selectable to activate a different audio output device (e.g., a speaker and/or headphones) for outputting the audio of the emergency call, mute element 608-3 is selectable to mute or unmute the microphone of device 600, end element 608-5 is selectable to terminate the call, and keypad element 608-6 is selectable to cause device 600 to display a keypad. When an emergency call is established at device 600, call elements 608 include live video element 608-2 and media-sharing element 608-4, which are both disabled in FIG. 6B as indicated by the shaded appearance. When a live-video-sharing feature has been enabled by the emergency service provider, live video element 608-2 is selectable (e.g., as indicated by a non-shaded appearance as shown in FIG. 6E or FIG. 6H) and can be selected to activate or deactivate the sharing of a live video feed with the emergency service provider. When a media-sharing feature has been enabled by the emergency service provider, media-sharing element 608-4 is selectable (e.g., as indicated by a non-shaded appearance as shown in FIG. 6L) and can be selected to share previously captured photos and/or videos with the emergency service provider. Device 600 only displays live video element 608-2 and media-sharing element 608-4 when an emergency call is active at device 600 (e.g., when device 600 is in an active call with an emergency service provider), and the live-video-sharing and media-sharing features are only available when they have been enabled by the emergency service provider (e.g., via the dispatcher). Thus, if a non-emergency call is established at device 600, call elements 608 are displayed without live video element 608-2 and without media-sharing element 608-4, and the live-video-sharing feature and the media-sharing feature cannot be enabled at device 600.

In FIG. 6C, device 600 receives data from the emergency service provider requesting the user of device 600 to share a live video feed with the dispatcher. Because the emergency call was initiated from user interface 602 while device 600 was in a locked state (e.g., and device 600 is in the locked state when the data is received from the emergency service provider), device 600 performs an authentication function before enabling the live-video-sharing feature, as indicated by the display of authentication interface 610 in FIG. 6C. After the user of device 600 is authenticated, device 600 enables the live-video-sharing feature and displays the user interface depicted in FIG. 6D, as described in greater detail below. If, however, the emergency call was initiated while device 600 was unlocked, or device 600 was otherwise unlocked at the time the data was received to enable the live-video-sharing feature, device 600 forgoes the authentication process and displays the user interface depicted in FIG. 6D without displaying authentication interface 610.

In response to receiving the data from the emergency service provider requesting the user of device 600 to share a live video feed (and, in some embodiments, after authenticating the user of device 600), device 600 displays request interface 614, requesting the user of device 600 to share live video with the emergency service provider (e.g., by sharing the live video feed with the representative of the emergency service provider). Request interface 614 includes share option 614-1 that is selectable to enable the sharing of a live video feed with the representative of the emergency service provider (e.g., by enabling the transmission of the live video feed to the emergency service provider) and decline option 614-2 that is selectable to decline the request to share a live video feed with the representative of the emergency service provider (and, in some embodiments, to cause device 600 to display call interface 606). In some embodiments, even if the user declines the request to share a live video feed (e.g., by selecting decline option 614-2), the live-video-sharing feature is enabled (e.g., in response to receiving the data requesting the user to share a live video feed), and device 600 displays live video element 608-2 in a selectable state (e.g., as shown in FIG. 6H) when displaying the call interface 606, and the user can select live video element 608-2 to activate a live video feed for sharing with the dispatcher as described in greater detail below.

In response to receiving the request to share a live video feed, device 600 activates camera(s) 600b and displays camera preview 612, showing a preview of the video feed (e.g., from camera(s) 600b) that will be transmitted to the dispatcher if the user accepts the request to share the live video feed. In some embodiments, camera preview 612 includes a control for switching between different cameras of device 600 (e.g., for switching from a front-facing camera to a rear-facing camera and vice-versa). As shown in FIG. 6D, device 600 displays camera indicator 616 in status region 607 to indicate that camera(s) 600b is activated. In some embodiments, if call interface 606 is not displayed when device 600 receives the request to share a live video feed, device 600 displays a banner with an element to decline the request (e.g., similar to option 614-2) and a “preview” element that is selectable to cause device 600 to display request interface 614 as shown in FIG. 6D. In some embodiments, if the data received from the emergency service provider corresponds to a request to share previously captured photos and/or videos, device 600 displays the interface depicted in FIG. 6J (e.g., after performing authentication), instead of displaying the interface depicted in FIG. 6D.

In response to detecting input 605-2 in FIG. 6D selecting share option 614-1, device 600 begins transmitting live video feed 618 captured by camera(s) 600b to the emergency service provider, as depicted in FIG. 6E. In some embodiments, device 600 transmits the live video feed as a simplex communication (e.g., a one-way data stream) from device 600 to the emergency service provider. In some embodiments, media data (e.g., the live video feed and/or selected media items) are communicated (e.g., transmitted) to the emergency service provider using a different communication channel than the audio call to the emergency service provider. In this way, communication of the media data can be managed independently from the audio communication with the emergency service provider. Device 600 displays video feed 618 depicting the video feed that is being shared with the emergency service provider and displays live video element 608-2 having a non-shaded appearance (e.g., indicating that the live-video-sharing feature is enabled at device 600) and having a bolded appearance with glyph 611 (e.g., providing further indication that the live-video-sharing feature is activated and the live video feed is currently being shared with the emergency service provider). In FIG. 6E, device 600 continues to display media-sharing element 608-4 with the shaded appearance because the media-sharing feature has not yet been enabled at device 600.

In response to detecting input 605-3 in FIG. 6E selecting end element 608-5, device 600 displays prompt 620 (e.g., as shown in FIG. 6F). Prompt 620 prompts the user of device 600 to confirm whether they intended to terminate the emergency call or to stop sharing the live video feed. Prompt 620 includes option 620-1, which is selectable to stop sharing the live video feed while continuing the emergency call. Prompt 620 also includes option 620-2, which is selectable to end the emergency call and stop sharing the live video feed. Prompt 620 also includes a cancel option that is selectable to return to the user interface depicted in FIG. 6E.

In some embodiments, when a user of device 600 navigates away from call interface 606, device 600 automatically stops the live video transmission while continuing the emergency call. For example, in FIG. 6G device 600 displays home screen 624 in response to input 605-4 in FIG. 6E (e.g., a gesture and/or other input corresponding to a request to display the home screen of device 600) and pauses the live video feed being transmitted to the emergency service provider. Device 600 displays emergency call indicators 622 in status region 607 to indicate that the emergency call is continuing and ceases to display camera indicator 616 to indicate that camera(s) 600b is no longer activated.

Referring now to FIG. 6H, device 600 displays call interface 606 with status indicator 626 showing that the live camera feed is paused. The user interface depicted in FIG. 6H can be displayed in response to detecting input 605-5 selecting the live video element 608-2 in FIG. 6E, or in response to detecting input 605-6 selecting status region 607 in FIG. 6G. The user interface depicted in FIG. 6H indicates that the emergency call is still active and that the live video feed is paused. In response to detecting input 605-7 selecting live video element 608-2 in FIG. 6H, device 600 unpauses or re-activates the live video feed, as depicted in FIG. 6I.

In FIG. 6J, device 600 receives data from the emergency service provider requesting the user of device 600 to share previously captured media (also referred to as a request to share media) with the emergency service provider (e.g., by transmitting user-selected photos and/or videos to the dispatcher). In the embodiments illustrated in the figures, the media being requested for sharing is photos; however, the request can be made for different or additional media such as videos or audio recordings or a combination of photos, videos, and/or audio recordings. In response to receiving the data corresponding to the request to share media, device 600 displays request interface 628, which includes option 628-1 that is selectable to display media items (e.g., photos and/or videos) that can be selected for sending to the emergency service provider and option 628-2 that is selectable to decline the request to share previously captured media with the emergency service provider. In some embodiments, selecting option 628-2 also causes device 600 to display call interface 606. In some embodiments, even if the user declines the request to share media (e.g., by selecting option 628-2), the media-sharing feature is enabled at device 600 (e.g., in response to receiving the data requesting the user to share media), and device 600 displays media-sharing element 608-4 in a selectable state (e.g., as shown in FIG. 6L) when displaying the call interface 606, and the user can select media-sharing element 608-4 to choose photos for sharing with the emergency service provider as described in greater detail below. In some embodiments, device 600 stops sharing the live video feed in response to receiving the request to share media. In some embodiments, device 600 automatically resumes sharing the video feed with the emergency service provider if the user declines the request to share media. For example, in response to detecting selection of option 628-2 in FIG. 6J, device 600 displays the user interface depicted in FIG. 6I (e.g., but with media-sharing element 608-4 shown in a selectable state). In some embodiments, device 600 does not automatically resume sharing the video feed with the dispatcher if the user declines the request to share media. For example, in response to detecting selection of option 628-2 in FIG. 6J, device 600 displays the user interface depicted in FIG. 6H (e.g., but with media-sharing element 608-4 shown in a selectable state). In some embodiments, if call interface 606 is not being displayed when device 600 receives the request to share media, device 600 displays a banner with an element to decline the request (e.g., similar to option 628-2) and a “choose” element (e.g., similar to option 628-1) that is selectable to cause device 600 to display a media library interface similar to that shown in FIG. 6K and described below.

In response to detecting input 605-8 in FIG. 6J selecting option 628-1, device 600 displays media library interface 630, which includes media items 632 that are selectable for sending to the emergency service provider. In some embodiments, media library interface 630 is displayed over call interface 606 and can be dragged down (e.g., in response to a downward drag input and/or gesture at the top of media library interface 630) toward the bottom of display 600a to reveal call interface 606. Media items 632 can include photos and/or videos that are available (e.g., stored or otherwise accessible) via device 600. The user can select one or more media items for sending to the emergency service provider while the emergency call is active at device 600. For example, in FIG. 6K, the user has selected media items 632-1 to 632-5 (e.g., by tapping on or otherwise selecting each of the respective media items), as indicated by respective checkmarks 633. In response to detecting input 605-9 selecting share element 634, device 600 transmits selected media items 632-1 to 632-5 to the emergency service provider, as shown in FIG. 6L. In the embodiment depicted in FIGS. 61-6L, device 600 automatically pauses the transmission of the live video feed when the request to share media is received at device 600. As shown in FIG. 6L, in response to detecting input 605-9 selecting share element 634, device 600 transmits the selected media items to the emergency service provider (e.g., as indicated by status notification 636) and automatically resumes transmission of the live video feed, as indicated by status indicator 626. In some embodiments, device 600 automatically resumes transmission of the live video feed after the photos are successfully transmitted. In some embodiments, device 600 automatically resumes transmission of the live video feed while the photos are being transmitted. Status notification 636 includes send progress indicator 636-1, recipient indicator 636-2, and text 636-3, which provide feedback to the user of device 600 about the status of the selected media items (e.g., media items 632-1 to 632-5) being transmitted to the emergency service provider. In some embodiments, media-sharing element 608-4 can be selected (e.g., via input 605-10) to display media library interface 630, enabling the user to select additional photos and/or videos for sending to the emergency service provider.

In some embodiments, device 600 continues to transmit the selected media items to the emergency service provider even if the emergency call is terminated (e.g., ended or disconnected) before transmission of the media items is complete. For example, in response to detecting input 605-11 selecting end element 608-5 in FIG. 6L, device 600 terminates the emergency call and continues to transmit the selected media items to the emergency service provider, as shown in FIG. 6M. Device 600 displays home screen 624 after terminating the emergency call, however, because device 600 continues to transmit the selected media items 632-1 to 632-5, device 600 displays send progress indicator 636-1 and recipient indicator 636-2 in status region 607. After the media items have been successfully transmitted to the emergency service provider, device 600 displays status notification 636 with updated text 636-3 as shown in FIG. 6N, indicating that the selected media items have been sent to the emergency service provider.

FIGS. 6O-6Q depict various user interfaces of an embodiment in which a request to share a live video feed is received while device 600 is in the process of transmitting selected media items to the emergency service provider. In FIG. 6O, device 600 is transmitting photos to the emergency service provider while the live-video-sharing feature has not been enabled at device 600 (e.g., as indicated by the shaded appearance of live video element 608-2). Device 600 displays status notification 636, including send progress indicator 636-1, recipient indicator 636-2, and text 636-3, providing feedback to the user of device 600 about the status of the selected media items being transmitted to the emergency service provider.

While device 600 displays the user interface depicted in FIG. 6O, the emergency service provider sends the request for the user of device 600 to share a live video feed with the emergency service provider. In some embodiments, instead of immediately displaying request interface 614 when receiving the data corresponding to the request to share a live video feed, device 600 delays the display of request interface 614 and continues to display send progress indicator 636-1 and recipient indicator 636-2 in status region 607, as shown in FIG. 6P. As discussed below, in some embodiments, display of the request interface is not delayed, but the transmission of the live video feed is delayed. In some embodiments, device 600 delays displaying request interface 614 until after the media items have been sent to the emergency service provider, as depicted in FIG. 6Q. In some embodiments, device 600 delays displaying request interface 614 for a predetermined period of time such as, for example, until at least a minimum amount of time has elapsed since device 600 started transmitting the selected media items (e.g., in response to selection of share element 634). By delaying the display of request interface 614, device 600 provides feedback to the user that the request to share a live video feed does not disrupt the transmission of the selected media items to the emergency service provider.

In some embodiments, if device 600 receives an input corresponding to a request to activate a live video feed while device 600 is transmitting the previously captured media items (e.g., 632-1, 632-2, 632-3, 632-4, and/or 632-5) to the emergency service provider, the device delays activation of the live video feed until the transmission of the media items is complete. For example, if live video element 608-2 is enabled and is selected while device 600 is transmitting the media items, device 600 delays the transmission of video feed (e.g., video feed 618) until after the items are sent to the emergency service provider. As another example, if device 600 detects selection of option 614-1 while device 600 is transmitting the media items, device 600 delays the transmission of the live video feed (e.g., video feed 618) until after the items are sent to the emergency service provider. By delaying the transmission of the live video feed, device 600 provides feedback to the user that the transmission of the live video feed does not disrupt the transmission of the selected media items to the emergency service provider.

FIGS. 6R-6V depict various user interfaces of an embodiment in which a request to share a live video feed is received while a chat feature (e.g., real-time text (RTT) and/or other chat feature) is enabled for the emergency call. FIG. 6R depicts device 600 displaying emergency call interface 606 including chat element 640. Live video element 608-2 and media-sharing element 608-4 are disabled because the emergency service provider has not yet sent a request for the user to share a live video feed or media items.

In response to detecting input 605-12 selecting chat element 640 in FIG. 6R, device 600 enables an RTT messaging feature to enable real-time text messaging between the emergency service provider and the user of device 600. As shown in FIG. 6S, device 600 displays messaging interface 642, which includes messages transcript region 642-1, depicting text messages that have been communicated between device 600 and the dispatcher at the emergency service provider. In FIG. 6S, device 600 receives data that corresponds to a request to share a live video feed with the emergency service provider. In response to receiving the data, device 600 displays emergency call interface 606 including request interface 614 with camera preview 645, as depicted in FIG. 6T. In response to detecting input 605-13 selecting the sharing option 614-1, device 600 begins sharing live video feed 644, as depicted in FIG. 6U. Because the RTT messaging feature is activated, device 600 displays message transcript region 646 overlaid on video feed 644. Message transcript region 646 includes text 648 of the messaging conversation between the user of device 600 and the dispatcher. Accordingly, device 600 is able to share the live video feed with the emergency service provider while also staying in phone communication with the dispatcher. In response to detecting selection of message transcript region 646 (e.g., via input 605-14 in FIG. 6U), device 600 displays messaging interface 642 and reduces the displayed size of video feed 644, which is displayed as a picture-in-picture (PiP) window in FIG. 6V. As shown in FIG. 6V, messaging interface 642 includes an updated transcript of the messages between the user of device 600 and the dispatcher, as indicated by the display of text 648 in message conversation region 642-1. By displaying messaging interface 642 concurrently with the PiP window of video feed 644, device 600 enables the user to send messages to the emergency service provider while continuing to share the live video feed (e.g., allowing the user to view the video feed being transmitted to the emergency service provider). In some embodiments, device 600 returns to the user interface depicted in FIG. 6U (e.g., returns to an enlarged view of video feed 644 with message transcript region 646 overlaid on the video feed) in response to detecting an input selecting the PiP window of video feed 644. In this way, the user of the device can navigate between the user interfaces in FIGS. 6U and 6V while continuing to share the live video feed and communicate with the emergency service provider.

FIGS. 6W-6Y depict various user interfaces for accessing, after the emergency call has ended, media items that were shared with the emergency service provider during the emergency call. FIG. 6W depicts call history interface 650, which depicts prior calls that were made or received at device 600. Call history interface 650 includes call item 652, which represents the emergency call described above with respect to FIGS. 6A-6N. Call item 652 includes party identifier 652-1 indicating that the call was an emergency call to “911” and content identifier 652-2 indicating content (e.g., a live video feed and five media items) that was shared with the emergency service provider during the emergency call. In response to detecting selection of details element 652-3 (e.g., via input 605-15), device 600 displays call details interface 654 as shown in FIG. 6X, which provides additional information related to the call represented by call item 652. Call details interface 654 includes shared content item 656, which includes text 656-1 indicating the content that was shared during the emergency call. In response to detecting input 605-16 selecting shared content item 656, device 600 displays shared content interface 658, which includes media region 660 including representations of the media content that was transmitted to the emergency service provider. As shown in FIG. 6Y, media region 660 includes media items 632-1 to 632-5, which were shared with the emergency service provider as described above. In some embodiments, device 600 displays an enlarged view of the shared content in response to detecting a selection of the corresponding media item. For example, selecting media item 632-2 causes device 600 to display an enlarged view of media item 632-2. In some embodiments, the shared media items can include a video and selecting the video causes device 600 to play the shared video. In some embodiments, media region 660 includes a recording of the live video feed that was shared with the emergency service provider. In some embodiments, device 600 displays shared content interface 658 in response to detecting selection of details element 652-3 (e.g., without an intervening display of details interface 654). In some embodiments, the items in media region 660 are items that were shared in the emergency call corresponding to call item 652. In some embodiments, media region 660 include items that were shared in other emergency calls (e.g., emergency calls made before and/or after the emergency call depicted in FIGS. 6A-6N).

FIG. 7 is a flow diagram illustrating a method for sharing media during an emergency call using a computer system in accordance with some embodiments. Method 700 is performed at a computer system (e.g., 100, 300, 500, and/or 600) (e.g., a smartphone, a wearable device (e.g., a smartwatch), a tablet computer, a desktop computer, a laptop computer, and/or a head-mounted device (e.g., a head-mounted augmented reality and/or extended reality device)) that is in communication with (e.g., includes and/or is connected to) one or more display generation components (e.g., 112, 340, 504, and/or 600a) (e.g., a display controller, a touch-sensitive display system, a display screen, a monitor, a projector, a holographic display, and/or a head-mounted display system) and one or more input devices (e.g., 112, 350, 355, 508, 522, and/or 600a) (e.g., a touch-sensitive surface, a keyboard, mouse, trackpad, one or more optical sensors for detecting gestures, one or more capacitive sensors for detecting hover inputs, and/or accelerometer/gyroscope/inertial measurement units). Some operations in method 700 are, optionally, combined, the orders of some operations are, optionally, changed, and some operations are, optionally, omitted. In some embodiments, techniques described with reference to method 700 are applied to a non-emergency call and/or a call with an entity other than an emergency service provider (e.g., a call with a contactable entity that is designated by a user of the computer system as an emergency contact).

As described below, method 700 provides an intuitive way for sharing media during an emergency call. The method reduces the cognitive burden on a user for sharing media during an emergency call, thereby creating a more efficient human-machine interface. For battery-operated computing devices, enabling a user to share media during an emergency call faster and more efficiently conserves power and increases the time between battery charges.

Unless specified otherwise, the computer system (e.g., 600) performs the steps of method 700 while an emergency call (e.g., a call between the computer system (e.g., 600) and an entity and/or number designated as an emergency service, such as a call with 911 (in the United States), a call with 110/120/119 (in China), a call with 999 (in Hong Kong), a call with 122 (in India), a call with 110 or 119 (in Japan), a call 112 or 119 (in the Republic of Korea), a call with 112 (in Denmark), a call with 110 or 112 (in Germany), a call with 999 or 112 (in the United Kingdom), a police service, an EMT service, an ambulance service, a fire department service, and/or other emergency service) is active (e.g., connected, ongoing, and/or established) between the computer system and a first entity (e.g., a dispatcher, an operator, and/or other emergency services personnel or a communication system associated therewith). In some embodiments, the computer system is not capable of performing some of the steps of method 700 when an emergency call is not active at the computer system.

The computer system (e.g., 600) receives (702) first data from the first entity (e.g., from an external computer system associated with the first entity), wherein the first data corresponds to (e.g., includes, is, and/or represents) a request (e.g., 614 and/or 628) to share media with the first entity (e.g., a request for the computer system to share media with the dispatcher, operator, and/or emergency services personnel). In response to receiving the first data, the computer system displays (704), via the one or more display generation components (600a), a set of one or more options (e.g., 614-1, 614-2, 628-1, and/or 628-2) for sharing media with the first entity (e.g., a set of one or more selectable user interface elements (e.g., an icon, a button, an affordance, and/or a user-interactive graphical user interface object) that are selectable to accept or decline a request to share media with the dispatcher, operator, and/or emergency services personnel). In some embodiments, the set of one or more options for sharing media with the first entity includes a “share” option (e.g., 614-1) that is selectable to share a live video feed (e.g., 618) with the first entity. In some embodiments, the set of one or more options for sharing media with the first entity includes a “choose” option (e.g., 628-1) that is selectable to initiate the selection of previously captured media items (e.g., 632) (e.g., photos and/or videos) for sharing with the first entity. In some embodiments, the set of one or more options for sharing media with the first entity includes a “preview” option for displaying a preview (e.g., 612) of the video feed and, optionally, other options (e.g., 614-1 and/or 614-2) for sharing media with the first entity. In some embodiments, the set of one or more options for sharing media with the first entity includes a “not now” option (e.g., 614-2 and/or 628-2) for dismissing the request to share media with the first entity.

The computer system (e.g., 600) receives (706), via the one or more input devices (e.g., 600a), a set of one or more inputs (e.g., 605-2 or 605-8) directed to the set of one or more options (e.g., 614-1 and/or 628-1) for sharing media with the first entity. In response (708) to receiving the set of one or more inputs directed to the set of one or more options for sharing media with the first entity, the computer system performs (e.g., conditionally performs) the following steps. In accordance with a determination that the set of one or more inputs includes a selection (e.g., 605-2 or 605-8) of a first option (e.g., 614-1 or 628-1) (e.g., a selection of an “accept” option, a “share” option, and/or a “choose” option) for sharing media with the first entity, the computer system (e.g., 600) initiates (710) a process for sharing media with the first entity (e.g., transmitting media to the first entity). In accordance with a determination that the set of one or more inputs does not include a selection of the first option (e.g., not selecting the first option and, optionally, selecting a “decline” or “not now” option) for sharing media with the first entity, the computer system forgoes (712) initiating a process for sharing media with the first entity. Displaying a set of one or more options for sharing media with the first entity in response to receiving first data from the first entity that corresponds to a request to share media with the first entity reduces the number of inputs needed share media with the first entity. In some embodiments, an input in method 700 includes a touch gesture (e.g., on a touch-sensitive surface), an air gesture, a voice command, a press (e.g., of a button), a gaze, and/or a directional input (e.g., on a joystick and/or other directional input device).

In some embodiments, the process for sharing media with the first entity includes sharing a live video feed (e.g., 618 and/or 644) (e.g., a video captured, during the emergency call, using one or more cameras (e.g., 600b) that are in communication with the computer system (e.g., 600)) with the first entity. In some embodiments, the shared media includes a live video feed. In some embodiments, the process for sharing media with the first entity includes sharing previously captured media (e.g., 632, 632-1, 632-2, 632-3, 632-4, and/or 632-5) (e.g., media items (e.g., photos and/or videos) that are captured prior to the emergency call) with the first entity. In some embodiments, the shared media includes previously captured media (e.g., photos and/or video).

In some embodiments, the computer system (e.g., 600) is in communication with a camera (e.g., 600b) (e.g., an infrared camera, a depth camera, and/or a visible light camera). In response to receiving the first data, the computer system activates the camera and displays (e.g., concurrently with the set of one or more options (e.g., 614-1, and/or 614-2) for sharing media with the first entity) a representation (e.g., 612) of a live video feed captured using the camera (e.g., a camera preview). Activating the camera and displaying a representation of a live video feed captured using the camera in response to receiving the first data provides improved feedback by providing a preview of the media content to be shared with the first entity. In some embodiments, in response to receiving the request to share media with the first entity, the computer system automatically activates the camera and displays a camera feed. In some embodiments, the camera feed is a preview of the camera feed that is to be shared with the first entity.

In some embodiments, the process for sharing media with the first entity includes transmitting media (e.g., 618, 632, 632-1, 632-2, 632-3, 632-4, 632-5, and/or 644) (e.g., a live video feed and/or previously captured media items) from the computer system (e.g., 600) to the first entity (e.g., to the external computer system associated with the first entity) without receiving media from the first entity (e.g., the media sharing is a one-way data stream (e.g., a simplex communication) from the computer system to the external computer system of the first entity). In some embodiments, after accepting the request to share media with the first entity (e.g., via the set of one or more inputs directed to the set of one or more options for sharing media with the first entity), the computer system establishes a data connection with the external computer system for sharing media with the first entity. In some embodiments, the data connection is a one-way communication from the computer system to the first entity. In some embodiments, the data connection is a different communication channel than the communication channel used for the audio connection with the first entity.

In some embodiments, while the emergency call is active between the computer system (e.g., 600) and the first entity (and, in some embodiments, while the computer system is sharing media (e.g., 618 and/or 644) with the first entity), the computer system displays, via the one or more display generation components (e.g., 600a), a video option (e.g., 608-2) that is selectable to change a video transmission state for the computer system (e.g., to activate or deactivate the live video feed). The computer system receives, via the one or more input devices, a selection (e.g., 605-5 or 605-7) of the video option; and in response to receiving the selection of the video option: in accordance with a determination that the computer system is in a first video transmission state in which the computer system is transmitting video data (e.g., 618) to the first entity (e.g., as shown in FIG. 6E) (e.g., sharing media with the first entity by transmitting a live video feed to the external computer system associated with the first entity) during the emergency call, deactivating the transmission of video data to the first entity while the emergency call is active (e.g., the computer system ceases or pauses the live video feed while the emergency call remains active (e.g., connected to the first entity)). Displaying a video option that is selectable to change a video transmission state for the computer system reduces the number of inputs needed to activate or deactivate the transmission of video data to the first entity while the emergency call is active. In some embodiments, in response to receiving the selection of the video option and in accordance with a determination that the computer system is in a second video transmission state in which the computer system is not transmitting video data to the first entity during the emergency call (e.g., as shown in FIG. 6H), the computer system activates (or reactivates) the transmission of video data to the first entity while the emergency call is active (e.g., remains active).

In some embodiments, while the emergency call is active between the computer system (e.g., 600) and the first entity, the computer system performs the following steps. Prior to receiving the first data that corresponds to a request to share media with the first entity, the computer system displays, via the one or more display generation components (e.g., 600a), a first media sharing option (e.g., 608-2 and/or 608-4) having a disabled state (e.g., as shown in FIG. 6B) (e.g., the first media sharing option is not selectable). In some embodiments, the first media sharing option has a deemphasized appearance (e.g., greyed out and/or shaded) when the first media sharing option is disabled. In response to receiving the first data that corresponds to a request to share media with the first entity, the computer system enables the first media sharing option (e.g., the computer system enables selection of the first media sharing option) (e.g., 608-2 is enabled as shown in FIG. 6E or 608-4 is enabled as shown in FIG. 6L). Enabling the first media sharing option in response to receiving the first data that corresponds to a request to share media with the first entity provides improved feedback about a state of the computer system (e.g., indicating a state in which the computer system has been enabled and/or authorized by the first entity to share media content). In some embodiments, the option to share media is disabled until the request to share media is received from the first entity. In some embodiments, the first media sharing option changes appearance to indicate that the first media sharing option is enabled. For example, the first media sharing option is greyed out, shaded, deemphasized, and/or has another appearance indicating that it is disabled and/or not selectable until the first data is received. The computer system then changes the first media sharing to a non-greyed out, highlighted, emphasized, non-shaded, and/or other appearance indicating that it is enabled and/or selectable. In some embodiments, the first media sharing option, when enabled, is selectable to activate or deactivate the process for sharing media with the first entity. Enabling the first media sharing option to be selectable provides additional control options for activating or deactivating the process for sharing media with the first entity. In some embodiments, the first media sharing option is the first option (e.g., 614-1 or 628-1) for sharing media with the first entity. In some embodiments, the first media sharing option is different from the first option for sharing media with the first entity. In some embodiments, the first media sharing option is a different button than the first option but is selectable to perform the same function as the first option (e.g., the first media sharing option and the first option are both selectable to initiate a process for sharing media with the first entity).

In some embodiments, while the emergency call is active between the computer system (e.g., 600) and the first entity and the computer system is sharing media (e.g., 618 and/or 644) with the first entity, the computer system displays, via the one or more display generation components (e.g., 600a), a call user interface (e.g., 606) for the emergency call. In some embodiments, the computer system receives, via the one or more input devices (e.g., 600a), a request (e.g., 605-4) to cease display of the call user interface for the emergency call (e.g., an input for dismissing the call UI, an input for accessing an application at the computer system, and/or an input for displaying a user interface (e.g., 624) that is different from the call user interface). In response to receiving the request to cease display of the call user interface for the emergency call, the computer system ceases display of the call user interface and ceases (e.g., automatically and/or without detecting further user input) sharing media with the first entity (e.g., the computer system terminates or pauses the sharing of the live video feed with the first entity) (e.g., as shown in FIG. 6G). Ceasing display of the call user interface and automatically ceasing sharing media with the first entity in response to receiving the request to cease display of the call user interface for the emergency call performs an operation when a set of conditions has been met without requiring further user input. In some embodiments, the live video feed automatically stops being shared with the first entity if the user leaves the call user interface. In some embodiments, when the computer system ceases display of the call user interface, the computer system displays a banner or notification with an indication that the camera or video feed is paused.

In some embodiments, the first option for sharing media with the first entity corresponds to an option (e.g., 628-1) for selecting one or more previously captured media items (e.g., 632) for sharing with the first entity. In some embodiments, in response to receiving the request to share media with the first entity, the computer system (e.g., 600) displays an option (e.g., 628-1) for selecting previously captured media items to be shared with the first entity. Displaying an option for selecting one or more previously captured media items provides additional control options for sharing previously captured media with the first entity. In some embodiments, the process for sharing media with the first entity includes: displaying a set of one or more previously captured media items (e.g., 632); receiving a set of one or more inputs, including inputs selecting one or more media items (e.g., 632-1, 632-2, 632-3, 632-4, and/or 632-5) from the set of one or more previously captured media items (e.g., and including, in some embodiments, a selection (e.g., 605-9) of an element (e.g., 634) for initiating transmission of the selected media items); and transmitting the selected media items to the first entity. In some embodiments, the process for sharing media with the first entity includes receiving a selection of previously captured media items and transmitting the selected media items to the first entity. In some embodiments, while transmitting the selected media items to the first entity (e.g., before the transmission of the selected media items is complete), the computer system detects termination of the emergency call and continues transmitting the selected media items to the first entity after termination of the emergency call (e.g., as shown in FIGS. 6M and 6N). Continuing to transmit the selected media items to the first entity after termination of the emergency call performs an operation when a set of conditions has been met without requiring further user input. In some embodiments, the computer system continues to transmit the selected media items to the first entity even if the emergency call ends before the transmission is complete. In some embodiments, the computer system displays a confirmation banner or other such notification (e.g., 636 as shown in FIG. 6N) to inform the user that the transmission of the selected media item(s) is complete.

In some embodiments, while the emergency call is active between the computer system (e.g., 600) and the first entity and the computer system is sharing a live video feed (e.g., 618 and/or 644) with the first entity, the computer system receives second data from the first entity, wherein the second data corresponds to a request to share one or more previously captured media items (e.g., 632) (e.g., photos and/or videos) with the first entity. In response to receiving the second data, the computer system pauses (e.g., the computer system temporarily disables or stops) the sharing of the live video feed with the first entity (e.g., while continuing the emergency call) and displays a prompt (e.g., 628) to share one or more previously captured media items with the first entity. Pausing the sharing of the live video feed with the first entity and displaying a prompt to share one or more previously captured media items with the first entity in response to receiving the second data provides improved feedback indicating that the first entity is requesting the computer system to share previously captured media items. In some embodiments, the prompt includes an option (e.g., 628-1) that is selectable to initiate a process for selecting one or more previously captured media items for sharing with the first entity.

In some embodiments, after displaying the prompt (e.g., 628) to share one or more previously captured media items (e.g., 632) with the first entity, the computer system (e.g., 600) receives a set of one or more inputs (e.g., including input 605-9) corresponding to selection of one or more previously captured media items (e.g., 632-1, 632-2, 632-3, 632-4, and/or 632-5) for sharing with the first entity. In response to receiving the set of one or more inputs corresponding to the selection of one or more previously captured media items for sharing with the first entity, the computer system transmits the selected previously captured media items to the first entity and resumes (e.g., automatically without further user input) the sharing of the live video feed with the first entity (e.g., as shown in FIG. 6L). Resuming the sharing of the live video feed with the first entity and transmitting the selected previously captured media items to the first entity performs an operation when a set of conditions has been met without requiring further user input. In some embodiments, resuming the sharing of the live video feed with the first entity includes unpausing, reenabling, and/or continuing the sharing of the live video feed with the first entity. In some embodiments, the computer system automatically resumes sharing the live video feed with the first entity after transmitting the selected previously captured media items to the first entity (e.g., after the transmission of the selected media items is complete). In some embodiments, the computer system resumes sharing the live video feed with the first entity while the transmission of the selected previously captured media items continues (e.g., as a background process).

In some embodiments, while the emergency call is active between the computer system (e.g., 600) and the first entity, and the computer system is transmitting media items (e.g., 632-1, 632-2, 632-3, 632-4, and/or 632-5) (e.g., photos and/or videos) to the first entity, the computer system receives third data from the first entity, wherein the third data corresponds to a request to share a live video feed with the first entity. After receiving the third data (e.g., and, in some embodiments, in response to receiving one or more inputs corresponding to selection of an option (e.g., 614-1 and/or 608-2) for enabling the sharing of a live video feed with the first entity) (e.g., and, in some embodiments, in accordance with a determination that the transmission of the media items to the first entity is not complete (e.g., the transmission is ongoing or in progress)), the computer system initiates a process for sharing a live video feed (e.g., 618 and/or 644) with the first entity, wherein the sharing of the live video feed is delayed for a predetermined period of time after the process for sharing the live video feed is initiated (e.g., the start of sharing is delayed for a predetermined amount of time (e.g., 2 seconds, 3 seconds, or 5 seconds) and/or until a process is complete such as the transmission of the media items to the first entity). Initiating a process for sharing a live video feed with the first entity after receiving the third data, wherein the sharing of the live video feed is delayed for a predetermined period of time after the process for sharing the live video feed is initiated, provides improved feedback indicating to a user of the computer system that the sharing of the live video feed did not cancel or disrupt the transmission of the media items to the first entity.

In some embodiments, initiating the process for sharing media (e.g., 618 and/or 644) with the first entity includes the following steps. In accordance with a determination that a first communication mode is activated at the computer system (e.g., 600) (e.g., a chat feature (e.g., 640) for communicating with the first entity using text), the computer system displays, via the one or more display generation components (e.g., 600a), a representation of a live video feed (e.g., 644) (e.g., a live video feed of one or more cameras of the computer system that is being transmitted from the computer system to the first entity) having a text transcript (e.g., 646 and/or 648) (e.g., a live text transcript of communication between the user of the computer system and the first entity) displayed over (e.g., overlaid) at least a portion of the live video feed. In accordance with a determination that the first communication mode is not activated at the computer system, the computer system displays, via the one or more display generation components, the representation of the live video feed without a text transcript displayed over at least a portion of the live video feed. Displaying the representation of the live video feed having a text transcript displayed over at least a portion of the live video feed when the first communication mode is activated provides improved feedback by enabling concurrent display of the text transcript while sharing media with the first entity. In some embodiments, while displaying the representation of the live video feed (e.g., 644) having a first appearance (e.g., an enlarged and/or full-screen display state) with the text transcript (e.g., 646 and/or 648) displayed over at least a portion of the live video feed (e.g., as depicted in FIG. 6U), the computer system receives, via the one or more input devices (e.g., 600a), an input (e.g., 605-14) directed to the text transcript. In response to receiving the input directed to the text transcript, the computer system displays: a messaging user interface (e.g., 642) (e.g., a user interface for a messaging application) that includes the text transcript (e.g., 648); and the representation of the live video feed (e.g., 644) having a second appearance that is different from the first appearance and does not include the text transcript (e.g., as depicted in FIG. 6V) (e.g., the live video feed is displayed as a picture-in-picture (PiP) window that is displayed concurrently with the messaging user interface). Displaying a messaging user interface that includes the text transcript and displaying the representation of the live video feed having the second appearance in response to receiving the input directed to the text transcript provides additional control options for communicating with the first entity while sharing the media with the first entity. In some embodiments, the representation of the live video feed is displayed (e.g., as a PiP window) over at least a portion of the messaging user interface. In some embodiments, the live video feed can be selected while having the second appearance and, in response, the computer system displays the live video feed having the first appearance (e.g., reverting to the live video feed with the text transcript overlay).

In some embodiments, after sharing media (e.g., 618, 632-1, 632-2, 632-3, 632-4, 632-5, and/or 644) with the first entity (in some embodiments, after termination of the emergency call), the computer system (e.g., 600) displays a call history user interface (e.g., 650) (e.g., a call history that includes a call history item (e.g., 652) that represents the emergency call with the first entity) that includes an indication (e.g., 652-2) of one or more media items shared with the first entity during the emergency call. Displaying a call history user interface that includes an indication of one or more media items shared with the first entity during the emergency call provides improved feedback indicating media items shared with the with the first entity during a previous emergency call with the first entity. In some embodiments, the indication (e.g., 652-2) includes text and/or a glyph or other indication that video, photos, and/or a live video feed were shared with the first entity during the emergency call. In some embodiments, the indication indicates how many media items (e.g., how many videos, photos, and/or live video feeds) were shared with the first entity. In some embodiments, the computer system receives, via the one or more input devices (e.g., 600a), an input (e.g., 605-15) (or a set of one or more inputs such as inputs 605-15 and 605-16) that includes a selection of a call history item (e.g., 652) from the call history user interface that corresponds to a respective emergency call (e.g., a previous emergency call) between the computer system and the first entity. In response to receiving the input that includes the selection of the call history item from the call history user interface that corresponds to the respective emergency call between the computer system and the first entity, the computer system displays a representation (e.g., 632-1, 632-2, 632-3, 632-4, 632-5, and/or 660) (e.g., text and/or thumbnail images) of one or more media items that were shared with the first entity during the respective emergency call. Displaying a representation of one or more media items that were shared with the first entity during the respective emergency call provides improved feedback indicating specific media content that was shared with the first entity during a respective emergency call. In some embodiments, the representation of the one or more media items that were shared with the first entity during the respective emergency call includes a copy of live video feed, media, links, and/or documents shared with the first entity during the respective emergency call. In some embodiments, the representation of one or more media items includes a representation of media items that were shared with the first entity in other emergency calls (different from the respective emergency call) with the first entity. In some embodiments, the computer system performs an authentication process (e.g., to authenticate a user for access to the representation of the one or more media items) before displaying the representation of the shared media items. In some embodiments, a representation of a media item that was shared is selectable to view the corresponding media item.

In some embodiments, in response to receiving the first data (and, in some embodiments, prior to displaying the set of one or more options (e.g., 614-1, 614-2, 628-1, and/or 628-2) for sharing media with the first entity), the computer system (e.g., 600) performs the following steps. In accordance with a determination that the emergency call was initiated while the computer system was in a locked state (e.g., as depicted in FIG. 6A) (e.g., the emergency call was initiated from a lock screen or another user interface while the computer system is in the locked state), the computer system performs authentication of a user of the computer system (e.g., as depicted in FIG. 6C) prior to displaying the set of one or more options (e.g., 614-1, 614-2, 628-1, and/or 628-2) for sharing media with the first entity (e.g., displaying the set of one or more options for sharing media with the first entity after the user is successfully authenticated). Performing authentication of a user of the computer system prior to displaying the set of one or more options for sharing media with the first entity when the emergency call was initiated while the computer system was in a locked state improves privacy by ensuring that an authorized user is permitted to share media from the computer system with the first entity. In some embodiments, in a locked state the computer system is powered on and operational but is prevented from performing a predefined set of operations in response to user input. In some embodiments, in a locked state the computer system requires and/or prompts a user for authentication information, such as a passcode and/or biometric information, in order to provide access to one or more functions (e.g., the predefined set of operations) of the computer system. In some embodiments, if the emergency call was initiated while the computer system was in an unlocked state, or if the user has been authenticated prior to receiving the first data, the computer system displays the set of one or more options for sharing media with the first entity without again authenticating the user.

Note that details of the processes described above with respect to method 700 (e.g., FIG. 7) are also applicable in an analogous manner to the methods described below. For example, method 900 optionally includes one or more of the characteristics of the various methods described above with reference to method 700. For example, media can be shared as described in method 700 during an emergency call described with respect to method 900. For brevity, these details are not repeated below.

FIGS. 8A-8K illustrate exemplary user interfaces for accessing content shared during a call, such as, e.g., an emergency call (e.g., a phone call with an emergency service provider), in accordance with some embodiments. The user interfaces in these figures are used to illustrate the processes described below, including the processes in FIG. 9.

FIG. 8A depicts device 600 while an emergency call is active with an emergency service provider (e.g., as described with reference to FIGS. 6A-6Y). Device 600 displays, via display 600a, call interface 806 (e.g., similar to call interface 606), including call elements 808 (e.g., similar to call elements 608). In the embodiment depicted in FIG. 8A, live video element 808-2 and media-sharing element 808-4 are shown in a selectable (e.g., non-shaded) state because the live-video-sharing feature and media-sharing feature are enabled. For example, device 600 has received respective requests to share a live video feed and to share media items. In the embodiment depicted in FIGS. 8A-8K, device 600 has previously shared a live video feed and media items, as described above with respect to FIGS. 6A-6Y.

In FIG. 8B, device 600 receives data from the emergency service provider corresponding to a request to share content with device 600. Specifically, the emergency service provider is requesting to share PSAP instructions with device 600. In response to receiving the data from the emergency service provider, device 600 displays call interface 806 with request interface 810 prompting the user of device 600 to access the instructions shared by the emergency service provider. Request interface 810 includes view option 810-1, decline option 810-2, and preview 804. View option 810-1 is selectable to view the instructions shared by the emergency service provider, and decline option 810-2 is selectable to decline the request to view the instructions shared by the emergency service provider. Preview 804 provides a preview of the instructions that are being shared by the emergency service provider.

In response to detecting input 805-1 selecting view option 810-1, device 600 displays instructions 812, which is displayed over call interface 806. In the embodiment depicted in FIG. 8C, instructions 812 is a document shared by the emergency service provider that includes instructions for performing CPR. In some embodiments, different content can be shared by the emergency service provider such as a link to the PSAP instructions or other PSAP instructions. In some embodiments, the document includes graphical elements that are selectable for navigating through the document. For example, in FIG. 8C, instructions 812 includes next element 812-1, which can be selected to navigate to a next page in the document. In response to detecting input 805-2 selecting next element 812-1, device 600 updates instructions 812 to display the next page in the document, as shown in FIG. 8D. The user of device 600 can navigate forward and backward through instructions 812 by selecting next element 812-1 and back element 812-2, respectively.

As shown in FIGS. 8C and 8D, device 600 displays instructions 812 overlaid on call interface 806, and device 600 can minimize or otherwise reduce the display of instructions 812 to reveal call interface 806. For example, in FIG. 8D, device 600 detects input 805-3 (e.g., a touch input with a downward dragging gesture at a top portion of instructions 812 and/or other input corresponding to a request to reduce the display of instruction 812). In response to detecting input 805-3, device 600 reduces the displayed area of instructions 812 by moving the instructions interface to a location at the bottom of display 600a, revealing call interface 806 and call elements 808, as shown in FIG. 8E. In some embodiments, device 600 expands instructions 812 (e.g., returning to the expanded state depicted in FIG. 8D) in response to detecting input 805-4 (e.g., a touch input with an upward dragging gesture at the top portion of instructions 812 in FIG. 8E and/or other input).

In some embodiments, content shared from the emergency service provider can be accessed even after the emergency call is ended. For example, FIGS. 8E-8K depict example interfaces for accessing the PSAP instructions shared by the emergency service provider in FIGS. 8B-8E. In FIG. 8E, device 600 detects input 805-5 selecting end element 808-5. In response to detecting input 805-5, device 600 terminates the emergency call. In FIG. 8F, device 600 displays home screen 824 and detects input 805-6 selecting call application icon 814. In response to detecting input 805-6, device 600 displays call history interface 830 (e.g., similar to call history interface 650). Call history interface 830 includes a list of prior calls made and received at device 600, including call item 832 corresponding to the emergency call depicted in FIGS. 8A-8E. Call item 832 includes party identifier 832-1 indicating that the call was an emergency call to “911” and content identifier 832-2 indicating content (e.g., media and instructions) that was shared during the emergency call. In response to detecting selection of details element 832-3 (e.g., via input 805-7), device 600 displays call details interface 834 as shown in FIG. 8H, which provides additional information related to the call represented by call item 832. Call details interface 834 includes shared content item 836, which includes text 836-1 indicating the content that was shared during the emergency call, specifically, a live video feed, five photos, and instructions. In response to detecting input 805-8 selecting shared content item 836, device 600 displays shared content interface 838, which includes media region 840 and shared content region 842. Media region 840 (e.g., similar to media region 660) includes representations of the media content that was transmitted to the emergency service provider. Shared content region 842 includes representations of content that was shared from the emergency service provider. As shown in FIG. 8I, shared content region 842 includes content item 844, which is a link to the PSAP instructions that were shared with device 600 during the emergency call as described above. In some embodiments, the items in media region 840 and shared content region 842 are items that were shared in the emergency call corresponding to call item 832. In some embodiments, media region 840 and shared content region 842 include items that were shared in other emergency calls (e.g., emergency calls made before and/or after the emergency call depicted in FIGS. 8A-8E). In some embodiments, the instructions can be accessed by selecting the items in shared content region 842. For example, in response to detecting input 805-9 selecting content item 844, device 600 displays user interface 846 prompting the user to access the shared PSAP instructions, as shown in FIG. 8J.

In FIG. 8J, device 600 detects input 805-10 selecting open option 846-1 and, in response, displays the shared PSAP instructions 848, which are displayed in web browser 850, as shown in FIG. 8K. PSAP instructions 848 include navigation icons 848-1 and 848-2 for navigating forward and backward, respectively, in the PSAP instructions webpage (e.g., similar to next element 812-1 and back element 812-2). In the embodiment depicted in FIGS. 8J and 8K, the PSAP instructions are accessed as a webpage. However, in some embodiments, the PSAP instructions can be accessed as a document (e.g., similar to instructions 812 depicted in FIGS. 8C-8D).

FIG. 9 is a flow diagram illustrating a method for accessing content shared during an emergency call using a computer system in accordance with some embodiments. Method 900 is performed at a computer system (e.g., 100, 300, 500, and/or 600) (e.g., a smartphone, a wearable device (e.g., a smartwatch), a tablet computer, a desktop computer, a laptop computer, and/or a head-mounted device (e.g., a head-mounted augmented reality and/or extended reality device)) that is in communication with (e.g., includes and/or is connected to) one or more display generation components (e.g., 112, 340, 504, and/or 600a) (e.g., a display controller, a touch-sensitive display system, a display screen, a monitor, a projector, a holographic display, and/or a head-mounted display system) and one or more input devices (e.g., 112, 350, 355, 508, 522, and/or 600a) (e.g., a touch-sensitive surface, a keyboard, mouse, trackpad, one or more optical sensors for detecting gestures, one or more capacitive sensors for detecting hover inputs, and/or accelerometer/gyroscope/inertial measurement units). Some operations in method 900 are, optionally, combined, the orders of some operations are, optionally, changed, and some operations are, optionally, omitted. In some embodiments, techniques described with reference to method 900 are applied to a non-emergency call and/or a call with an entity other than an emergency service provider (e.g., a call with a contactable entity that is designated by a user of the computer system as an emergency contact).

As described below, method 900 provides an intuitive way for accessing content shared during an emergency call. The method reduces the cognitive burden on a user for accessing content shared during an emergency call, thereby creating a more efficient human-machine interface. For battery-operated computing devices, enabling a user to access content shared during an emergency call faster and more efficiently conserves power and increases the time between battery charges.

Unless specified otherwise, the computer system (e.g., 600) performs the steps of method 900 while an emergency call (e.g., a call between the computer system (e.g., 600) and an entity and/or number designated as an emergency service, such as a call with 911 (in the United States), a call with 110/120/119 (in China), a call with 999 (in Hong Kong), a call with 122 (in India), a call with 110 or 119 (in Japan), a call 112 or 119 (in the Republic of Korea), a call with 112 (in Denmark), a call with 110 or 112 (in Germany), a call with 999 or 112 (in the United Kingdom), a police service, an EMT service, an ambulance service, a fire department service, and/or other emergency service) is active (e.g., connected, ongoing, and/or established) between the computer system and a first entity (e.g., a dispatcher, an operator, and/or other emergency services personnel or a communication system associated therewith). In some embodiments, the computer system is not capable of performing some of the steps of method 900 when an emergency call is not active at the computer system.

The computer system (e.g., 600) receives (902) first data from the first entity (e.g., from an external computer system associated with the first entity), wherein the first data corresponds to a request to access respective content (e.g., 812) (e.g., documents, resources, materials, and/or information) (e.g., a request for the computer system to access content shared with the computer system by the dispatcher, operator, and/or emergency services personnel). In some embodiments, the respective content includes Public Safety Answering Point (PSAP) content that is provided to assist in an emergency situation such as instructions for performing safety procedures such as CPR, the Heimlich maneuver, applying a tourniquet, and the like. In response to receiving the first data, the computer system displays (904), via the one or more display generation components (e.g., 600a), a set of one or more options (e.g., 810-1 and/or 810-2) for accessing the respective content (e.g., 812) (e.g., a set of one or more selectable user interface elements (e.g., an icon, a button, an affordance, and/or a user-interactive graphical user interface object) that are selectable to accept or decline a request to access the respective content shared by the dispatcher, operator, and/or emergency services personnel). In some embodiments, the set of one or more options for accessing the shared content includes a “view” option (e.g., 810-1) that is selectable to view the respective content that was shared by the first entity. In some embodiments, the set of one or more options for accessing the shared content includes a “not now” option (e.g., 810-2) for dismissing the request to access the respective content shared by the first entity.

The computer system (e.g., 600) receives (906), via the one or more input devices (e.g., 600a), a set of one or more inputs (e.g., 805-1) directed to the set of one or more options (e.g., 810-1) for accessing the respective content (e.g., 812). In response to receiving (908) the set of one or more inputs directed to the set of one or more options for accessing the respective content, the computer system performs (e.g., conditionally performs) the following steps. In accordance with a determination that the set of one or more inputs includes a selection (e.g., 805-1) of a first option (e.g., 810-1) (e.g., a selection of an “accept” option and/or a “view” option) for accessing the respective content (e.g., 812), the computer system displays (910), via the one or more display generation components (e.g., 600a), a representation (e.g., 812) (e.g., an image, a graphical object, a thumbnail, text, a webpage, a link to a webpage, a document, and/or a link to a document) of the respective content while continuing (e.g., maintaining the emergency call in the active state and/or without terminating the emergency call) the emergency call. In accordance with a determination that the set of one or more inputs does not include a selection of the first option (e.g., not selecting the first option and, optionally, selecting a “decline” or “not now” option) for accessing the respective content, the computer system continues (912) the emergency call without displaying the representation of the respective content. Displaying a representation of the respective content while continuing the emergency call when the set of one or more inputs includes a selection of the first option for accessing the respective content enhances the operability of the computer system by enabling the display of the respective content while remaining connected to the first entity during the emergency call. In some embodiments, an input in method 900 includes a touch gesture (e.g., on a touch-sensitive surface), an air gesture, a voice command, a press (e.g., of a button), a gaze, and/or a directional input (e.g., on a joystick and/or other directional input device).

In some embodiments, the respective content (e.g., 812 and/or 848) is shared with the computer system (e.g., 600) by the first entity (e.g., the respective content is shared from the dispatcher, operator, and/or other emergency services personnel). In some embodiments, the first entity shares a link and/or access to the content. In some embodiments, the first entity shares the content itself. In some embodiments, the first entity shares some combination of the content, a link, and access to the content.

In some embodiments, in response to receiving the first data, the computer system (e.g., 600) displays (e.g., concurrently with the set of one or more options (e.g., 810-1 and/or 810-2) for accessing the respective content) a preview (e.g., 804) of the respective content (e.g., 812) (e.g., a graphical representation of the respective content that is being shared). Displaying a preview of the respective content provides improved feedback by informing a user of the computer system of the content that is being shared by the first entity without requiring further input to access the respective content.

In some embodiments, in response to receiving the set of one or more inputs directed to the set of one or more options for accessing the respective content and in accordance with a determination that the set of one or more inputs includes a selection (e.g., 805-1 and/or 805-10) of the first option (e.g., 810-1 and/or 846-1) for accessing the respective content (e.g., 812 and/or 848), the computer system (e.g., 600) displays one or more navigation options (e.g., 812-1, 812-2, 848-1, and/or 848-2) (e.g., one or more icons, buttons, affordances, and/or user-interactive graphical user interface objects) for navigating (e.g., traversing) the respective content (e.g., the navigation options are selectable to navigate content provided in the respective content). Displaying the one or more navigation options for navigating the respective content provides improved feedback about the availability of content to be accessed and provides instructions for navigating the respective content to access said content. In some embodiments, when accessing the shared content, the computer system displays options to navigate the shared content. In some embodiments, the navigation options include a “next” option for traversing forward through the respective content (e.g., displaying a next page or next content in the respective content). In some embodiments, the navigation options include a “back” option for traversing backward through the respective content (e.g., displaying a previous page or previous content in the respective content).

In some embodiments, the representation of the respective content (e.g., 844, 846-1, and/or 848) corresponds to a webpage (e.g., 850) that includes the respective content (e.g., 848) (e.g., the shared content is available via a webpage). In some embodiments, the representation of the respective content includes a link to a webpage for accessing the respective content. In some embodiments, the representation of the respective content includes the webpage for accessing the respective content. In some embodiments, the representation of the respective content includes a preview of the webpage for accessing the respective content.

In some embodiments, the representation of the respective content (e.g., 812) corresponds to a document (e.g., a digital brochure, pamphlet, book, and/or article) that is displayed via the one or more display generation components (e.g., 600a). In some embodiments, the representation of the respective content includes a link (e.g., 844) to the document that includes the respective content. In some embodiments, the representation of the respective content includes the document. In some embodiments, the representation of the respective content includes a preview of the document for accessing the respective content.

In some embodiments, while the emergency call is active between the computer system (e.g., 600) and the first entity, the computer system performs the following steps. The computer system displays the representation of the respective content having a first displayed state (e.g., 812 as depicted in FIG. 8D) (e.g., a full screen view, enlarged view, and/or undocked state). The computer system receives, via the one or more input devices (e.g., 600a), an input (e.g., 805-3) directed to the representation of the respective content (e.g., an input corresponding to a request to resize, move, and/or dock the representation of the respective content). In response to receiving the input directed to the representation of the respective content, the computer system displays the representation of the respective content having a second displayed state (e.g., 812 as depicted in FIG. 8E) (e.g., a minimized view, reduced size view, and/or docked state) and displays (e.g., concurrently with the representation of the respective content having the second displayed state) a user interface (e.g., 806) for the emergency call (e.g., a user interface that includes one or more controls for the emergency call). Displaying the representation of the respective state having the second displayed state and displaying the user interface for the emergency call in response to receiving the input directed to the representation of the respective content reduces the number of inputs needed to access the emergency call user interface while the respective content is being displayed and the emergency call is active. In some embodiments, the user interface for the emergency call is not displayed or is at least partially hidden (e.g., by the representation of the respective content) while the representation of the respective content has the first displayed state and is revealed when the representation of the respective content has the second displayed state.

In some embodiments, after termination of the emergency call (e.g., after the emergency call has ended), the computer system (e.g., 600) displays, via the one or more display generation components (e.g., 600a), a second option (e.g., 832, 832-3, 836, 844, and/or 846-1) for accessing the respective content (e.g., 848) (e.g., a link or other selectable graphical user interface object). The computer system receives, via the one or more input devices (e.g., 600a), an input (e.g., 805-7, 805-8, 805-9, and/or 805-10) corresponding to a selection of the second option for accessing the respective content. In response to receiving the input corresponding to a selection of the second option for accessing the respective content, the computer system displays, via the one or more display generation components, a second representation of the respective content (e.g., 848) while the emergency call is inactive. Displaying a second option for accessing the respective content after termination of the emergency call reduces the number of inputs needed to access the respective content by eliminating the need to initiate an additional emergency call to access the respective content and preserves computational resources by providing access to the respective content without requiring the respective content to be stored at the computer system. In some embodiments, the second representation of the respective content is the same as the representation of the respective content. In some embodiments, the second representation of the respective content is a different version of the respective content. For example, the representation of the respective content is a document that is shared directly with the computer system, whereas the second representation of the respective content is a version of the document that is accessible at a website.

Note that details of the processes described above with respect to method 900 (e.g., FIG. 9) are also applicable in an analogous manner to the methods described above. For example, method 700 optionally includes one or more of the characteristics of the various methods described above with reference to method 900. For example, content shared during an emergency call can be accessed for an emergency call described with respect to method 700. For brevity, these details are not repeated.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the sharing of content during an emergency call. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver shared content based on user preferences or settings. Accordingly, use of such personal information data enables users to have calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of shared content, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

What is claimed is:

1. A computer system configured to communicate with one or more display generation components and one or more input devices, comprising:
one or more processors; and
memory storing one or more programs configured to be executed by the one or more processors, the one or more programs including instructions for:
while an emergency call is active between the computer system and a first entity:
receiving first data from the first entity, wherein the first data corresponds to a request to share media with the first entity;
in response to receiving the first data, displaying, via the one or more display generation components, a set of one or more options for sharing media with the first entity;
receiving, via the one or more input devices, a set of one or more inputs directed to the set of one or more options for sharing media with the first entity; and
in response to receiving the set of one or more inputs directed to the set of one or more options for sharing media with the first entity:
in accordance with a determination that the set of one or more inputs includes a selection of a first option for sharing media with the first entity, initiating a process for sharing media with the first entity; and
in accordance with a determination that the set of one or more inputs does not include a selection of the first option for sharing media with the first entity, forgoing initiating a process for sharing media with the first entity.

2. The computer system of claim 1, wherein the process for sharing media with the first entity includes sharing a live video feed with the first entity.

3. The computer system of claim 1, wherein the process for sharing media with the first entity includes sharing previously captured media with the first entity.

4. The computer system of claim 1, wherein the computer system is in communication with a camera, the one or more programs further including instructions for:
in response to receiving the first data:
activating the camera; and
displaying a representation of a live video feed captured using the camera.

5. The computer system of claim 1, wherein the process for sharing media with the first entity includes transmitting media from the computer system to the first entity without receiving media from the first entity.

6. The computer system of claim 1, the one or more programs further including instructions for:
while the emergency call is active between the computer system and the first entity:
displaying, via the one or more display generation components, a video option that is selectable to change a video transmission state for the computer system;
receiving, via the one or more input devices, a selection of the video option; and
in response to receiving the selection of the video option:
in accordance with a determination that the computer system is in a first video transmission state in which the computer system is transmitting video data to the first entity during the emergency call, disabling the transmission of video data to the first entity while the emergency call is active.

7. The computer system of claim 1, the one or more programs further including instructions for:
while the emergency call is active between the computer system and the first entity:
prior to receiving the first data that corresponds to a request to share media with the first entity, displaying, via the one or more display generation components, a first media sharing option having a disabled state; and
in response to receiving the first data that corresponds to a request to share media with the first entity, enabling the first media sharing option.

8. The computer system of claim 7, wherein the first media sharing option, when enabled, is selectable to activate or deactivate the process for sharing media with the first entity.

9. The computer system of claim 1, the one or more programs further including instructions for:
while the emergency call is active between the computer system and the first entity and the computer system is sharing media with the first entity:
displaying, via the one or more display generation components, a call user interface for the emergency call; and
receiving, via the one or more input devices, a request to cease display of the call user interface for the emergency call; and
in response to receiving the request to cease display of the call user interface for the emergency call, ceasing display of the call user interface and ceasing sharing media with the first entity.

10. The computer system of claim 1, wherein the first option for sharing media with the first entity corresponds to an option for selecting one or more previously captured media items for sharing with the first entity.

11. The computer system of claim 10, wherein the process for sharing media with the first entity includes:
displaying a set of one or more previously captured media items;
receiving a set of one or more inputs selecting one or more media items from the set of one or more previously captured media items; and
transmitting the selected media items to the first entity.

12. The computer system of claim 11, the one or more programs further including instructions for:
while transmitting the selected media items to the first entity, detecting termination of the emergency call; and
continuing transmitting the selected media items to the first entity after termination of the emergency call.

13. The computer system of claim 1, the one or more programs further including instructions for:
while the emergency call is active between the computer system and the first entity and the computer system is sharing a live video feed with the first entity, receiving second data from the first entity, wherein the second data corresponds to a request to share one or more previously captured media items with the first entity; and
in response to receiving the second data, pausing the sharing of the live video feed with the first entity and displaying a prompt to share one or more previously captured media items with the first entity.

14. The computer system of claim 13, the one or more programs further including instructions for:
after displaying the prompt to share one or more previously captured media items with the first entity, receiving a set of one or more inputs corresponding to selection of one or more previously captured media items for sharing with the first entity; and
in response to receiving the set of one or more inputs corresponding to the selection of one or more previously captured media items for sharing with the first entity:
transmitting the selected previously captured media items to the first entity; and
resuming the sharing of the live video feed with the first entity.

15. The computer system of claim 1, the one or more programs further including instructions for:
while the emergency call is active between the computer system and the first entity and the computer system is transmitting media items to the first entity, receiving third data from the first entity, wherein the third data corresponds to a request to share a live video feed with the first entity; and
after receiving the third data, initiating a process for sharing a live video feed with the first entity, wherein the sharing of the live video feed is delayed for a predetermined period of time after the process for sharing the live video feed is initiated.

16. The computer system of claim 1, wherein initiating the process for sharing media with the first entity includes:
in accordance with a determination that a first communication mode is activated at the computer system, displaying, via the one or more display generation components, a representation of a live video feed having a text transcript displayed over at least a portion of the live video feed; and
in accordance with a determination that the first communication mode is not activated at the computer system, displaying, via the one or more display generation components, the representation of the live video feed without a text transcript displayed over at least a portion of the live video feed.

17. The computer system of claim 16, the one or more programs further including instructions for:
while displaying the representation of the live video feed having a first appearance with the text transcript displayed over at least a portion of the live video feed, receiving, via the one or more input devices, an input directed to the text transcript; and
in response to receiving the input directed to the text transcript, displaying:
a messaging user interface that includes the text transcript; and
the representation of the live video feed having a second appearance that is different from the first appearance and does not include the text transcript.

18. The computer system of claim 1, the one or more programs further including instructions for:
after sharing media with the first entity, displaying a call history user interface that includes an indication of one or more media items shared with the first entity during the emergency call.

19. The computer system of claim 18, the one or more programs further including instructions for:
receiving, via the one or more input devices, an input that includes a selection of a call history item from the call history user interface that corresponds to a respective emergency call between the computer system and the first entity; and
in response to receiving the input that includes the selection of the call history item from the call history user interface that corresponds to the respective emergency call between the computer system and the first entity, displaying a representation of one or more media items that were shared with the first entity during the respective emergency call.

20. The computer system of claim 1, the one or more programs further including instructions for:
in response to receiving the first data:
in accordance with a determination that the emergency call was initiated while the computer system was in a locked state, performing authentication of a user of the computer system prior to displaying the set of one or more options for sharing media with the first entity.

21. A non-transitory computer-readable storage medium storing one or more programs configured to be executed by one or more processors of a computer system that is in communication with one or more display generation components and one or more input devices, the one or more programs including instructions for:
while an emergency call is active between the computer system and a first entity:
receiving first data from the first entity, wherein the first data corresponds to a request to share media with the first entity;
in response to receiving the first data, displaying, via the one or more display generation components, a set of one or more options for sharing media with the first entity;
receiving, via the one or more input devices, a set of one or more inputs directed to the set of one or more options for sharing media with the first entity; and
in response to receiving the set of one or more inputs directed to the set of one or more options for sharing media with the first entity:
in accordance with a determination that the set of one or more inputs includes a selection of a first option for sharing media with the first entity, initiating a process for sharing media with the first entity; and
in accordance with a determination that the set of one or more inputs does not include a selection of the first option for sharing media with the first entity, forgoing initiating a process for sharing media with the first entity.

22. A method, comprising:
at a computer system that is in communication with one or more display generation components and one or more input devices:
while an emergency call is active between the computer system and a first entity:
receiving first data from the first entity, wherein the first data corresponds to a request to share media with the first entity;
in response to receiving the first data, displaying, via the one or more display generation components, a set of one or more options for sharing media with the first entity;
receiving, via the one or more input devices, a set of one or more inputs directed to the set of one or more options for sharing media with the first entity; and
in response to receiving the set of one or more inputs directed to the set of one or more options for sharing media with the first entity:
in accordance with a determination that the set of one or more inputs includes a selection of a first option for sharing media with the first entity, initiating a process for sharing media with the first entity; and
in accordance with a determination that the set of one or more inputs does not include a selection of the first option for sharing media with the first entity, forgoing initiating a process for sharing media with the first entity.
